(19) United States
(12) Patent Application Publication
(10) Pub. No.: US 2017/0140209 A1
(43) Pub. Date: May 18, 2017

(54) IMAGE RECOGNITION METHOD AND DEVICE FOR GAME

(71) Applicant: Xiaomi Inc., Beijing (CN)

(72) Inventors: Zhijun Chen, Beijing (CN); Wendi Hou, Beijing (CN); Pingze Wang, Beijing (CN)

(73) Assignee: Xiaomi Inc., Beijing (CN)

(21) Appl. No.: 15/195,144

(22) Filed: Jun. 28, 2016

(30) Foreign Application Priority Data
Nov. 13, 2015 (CN) 201510778586.9

(51) Int. Cl. G06K 9/00; A63F 13/87; A63F 13/79; A63F 13/825; A63F 13/837; A63F 13/31; A63F 13/71; A63F 13/822

(52) U.S. Cl. CPC G06K 9/00268; G06K 9/00362; A63F 13/71; A63F 13/87; A63F 13/822; A63F 13/825; A63F 13/837; A63F 13/31; A63F 13/79

(57) ABSTRACT

An image recognition method and device for implementing game play features of a game related to the field of image processing is disclosed. By allowing a communication device controlled by a player participating in the game to capture images and apply the image recognition features on the captured images, game play operations may be applied to other players included in the captured image within a context of the game play of the game.

### CROSS-REFERENCE TO RELATED APPLICATIONS

This application claims priority to Chinese Patent Application No. 201510778586.9, filed on Nov. 13, 2015, the entirety of which is hereby incorporated by reference herein.

### TECHNICAL FIELD

The present disclosure generally relates to the field of image processing, and more particularly, to an image recognition method and device applicable for electronic games.

### BACKGROUND

Electronic games may offer different game play modes. In particular, online gaming has become a popular form of game play that allows players to interact with each other in live gaming environments via connection through a common communication network.

### SUMMARY

According to some embodiments, an image recognition method for a game is provided, which includes when an image to be matched is captured by an image capturing device, acquiring first body characteristic information corresponding to the captured image, determining a first user identifier corresponding to the first body characteristic information according to a pre-established relationship between a user identifier and body characteristic information, and executing a gaming operation according to the first user identifier.

According to some embodiments, an image recognition method for a game is provided, which includes receiving an image to be matched which is captured by an image capturing device included on a terminal, acquiring first body characteristic information corresponding to the captured image, determining a first user identifier corresponding to the first body characteristic information according to a pre-established relationship between a user identifier and body characteristic information, and executing a gaming operation according to the first user identifier.

According to some embodiments, an image recognition method for a game is provided, which includes when an image to be matched is captured by an image capturing device, acquiring first body characteristic information corresponding to the captured image, determining a first user identifier corresponding to the first body characteristic information according to a pre-established relationship between a user identifier and body characteristic information, and transmitting the first user identifier to a server where the server is configured to execute a gaming operation according to the first user identifier.

According to some embodiments, an image recognition device for a game is provided, which includes a processor and a memory configured to store instructions executable by the processor. The processor may be configured to, when an image to be matched is captured by an image capturing device, acquire first body characteristic information corresponding to the captured image, determine a first user identifier corresponding to the first body characteristic information according to a pre-established relationship between a user identifier and body characteristic information, and execute a gaming operation according to the first user identifier.

According to some embodiments, an image recognition device for a game is provided, which includes a processor and a memory configured to store instructions executable by the processor. The processor may be configured to receive an image to be matched which is captured by an image capturing device included in a terminal, acquire first body characteristic information corresponding to the captured image, determine a first user identifier corresponding to the first body characteristic information according to a pre-established relationship between a user identifier and body characteristic information, and execute a gaming operation according to the first user identifier.

According to some embodiments, an image recognition device for a game is provided, which includes a processor and a memory configured to store instructions executable by the processor. The processor may be configured to, when an image to be matched is taken, acquire first body characteristic information corresponding to the captured image, determine a first user identifier corresponding to the first body characteristic information according to a pre-established relationship between a user identifier and body characteristic information, and transmit the first user identifier to a server where the server is configured to execute a gaming operation according to the first user identifier.

According to some embodiments, there is provided a non-transitory computer-readable storage medium having stored therein instructions that, when executed by a processor of a terminal, causes the terminal to perform an image recognition method for a game. The method may comprise when an image to be matched is captured by an image capturing device and received by the processor, acquiring first body characteristic information corresponding to the captured image, determining a first user identifier corresponding to the first body characteristic information according to a pre-established relationship between a user identifier and body characteristic information, and executing a gaming operation according to the first user identifier.

According to some embodiments, there is provided a non-transitory computer-readable storage medium having stored therein instructions that, when executed by a processor of a server, causes the server to perform an image recognition method for a game. The method may comprise receiving an image to be matched which is taken by a terminal, acquiring first body characteristic information corresponding to the image to be matched, determining a first user identifier corresponding to the first body characteristic information according to a pre-established relationship between a user identifier and body characteristic information, and executing a shooting operation on the first user identifier.

According to some embodiments, there is provided a non-transitory computer-readable storage medium having stored therein instructions that, when executed by a processor of a terminal, causes the terminal to perform an image recognition method for a game. The method may comprise when a captured image is received by the processor, acquiring first body characteristic information corresponding to the captured image, determining a first user identifier corresponding to the first body characteristic information according to a pre-established relationship between a user identifier and body characteristic information, and transmitting the first user identifier to a server where the server is configured to execute a gaming operation according to the first user identifier.

According to some embodiments, an image recognition method is disclosed. The method may include receiving an image captured by an image capturing device, acquiring a first body characteristic information corresponding to a bodily attribute, determining whether a first user identifier satisfies a matching relationship with the first body characteristic information, and when the first user identifier is determined to satisfy the matching relationship with the first body characteristic information, performing a gaming operation on a player identified by the first user identifier.

According to some embodiments, an image recognition method is disclosed. The method may include receiving an image captured by an image capturing device, acquiring a first body characteristic information corresponding to a bodily attribute, determining whether a first user identifier satisfies a matching relationship with the first body characteristic information, and when the first user identifier is determined to satisfy the matching relationship with the first body characteristic information, transmitting the first user identifier to a server, wherein the server is configured to execute a gaming operation on a user identified by the first user identifier.

According to some embodiments, an image recognition device is disclosed. The image recognition device may include a processor and a memory. The memory may be configured to store instructions executable by the processor to receive an image captured by an image capturing device, acquire a first body characteristic information corresponding to a bodily attribute, determine whether a first user identifier satisfies a matching relationship with the first body characteristic information, and when the first user identifier is determined to satisfy the matching relationship with the first body characteristic information, execute a gaming operation on a user identified by the first user identifier.

According to some embodiments, an image recognition device is disclosed. The image recognition device may include a processor and a memory. The memory may be configured to store instructions executable by the processor to receive an image captured by an image capturing device, acquire a first body characteristic information corresponding to a bodily attribute, determine whether a first user identifier satisfies a matching relationship with the first body characteristic information, and when the first user identifier is determined to satisfy the matching relationship with the first body characteristic information, transmit the first user identifier to a server, wherein the server is configured to execute a gaming operation on a user identified by the first user identifier.

It should be understood that both the above general description and the following detailed description are only exemplary and explanatory and not intended to limit the present disclosure.

### BRIEF DESCRIPTION OF THE DRAWINGS

FIG. 1 shows a flow chart of logic implemented by a device, according to an exemplary embodiment.

FIG. 2 shows a flow chart of logic implemented by a device, according to another exemplary embodiment.

FIG. 3 is a system diagram illustrating an image recognition system, according to an exemplary embodiment.

FIG. 4 shows a flow chart of logic implemented by a device, according to another exemplary embodiment.

FIG. 5 shows a flow chart of logic implemented by a device, according to another exemplary embodiment.

FIG. 6 shows a flow chart of logic implemented by a device, according to another exemplary embodiment.

FIG. 7 shows a diagram showing structure of a terminal, according to an exemplary embodiment.

FIG. 8 shows a diagram showing structure of a terminal, according to another exemplary embodiment.

FIG. 9 shows a diagram showing structure of a terminal, according to another exemplary embodiment.

FIG. 10 shows a diagram showing structure of an image recognition device, according to another exemplary embodiment.

FIG. 11 shows a diagram showing structure of an image recognition device, according to another exemplary embodiment.

FIG. 12 shows a diagram showing structure of an image recognition device, according to another exemplary embodiment.

FIG. 13 shows a diagram showing structure of an image recognition device, according to another exemplary embodiment.

FIG. 14 shows a diagram showing structure of an image recognition device, according to another exemplary embodiment.

FIG. 15 shows a diagram showing structure of an image recognition device, according to another exemplary embodiment.

FIG. 16 shows a diagram showing structure of an image recognition device, according to another exemplary embodiment.

FIG. 17 shows a diagram showing structure of an image recognition device, according to another exemplary embodiment.

FIG. 18 shows a block diagram of an exemplary image recognition device, according to another exemplary embodiment.

FIG. 19 shows a block diagram illustrating an exemplary image recognition device, according to another exemplary embodiment.

### DETAILED DESCRIPTION

In order to make a purpose, technical solutions and advantages of the present disclosure clearer, implementation modes of the present disclosure will be further described below with reference to the accompanying drawings in detail.

Reference will now be made in detail to exemplary embodiments, examples of which are illustrated in the accompanying drawings. The following description refers to the accompanying drawings in which the same numbers in different drawings represent the same or similar elements unless otherwise represented. The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

This disclosure references, among other features, network games that allow multiple players to participate in a common gaming environment over a communication network. A network game may be available to run on a variety of communication devices connected to the communication network. For example, a network game that accesses and utilizes a communications network to connect players with the network game and with each other, may run on a mobile communication device such that multiple players controlling their respective mobile communication device may interact with each other within the common gaming environment. The mobile communication device may include an image capturing device (e.g., digital camera). In particular, this disclosure describes a gaming tool that may be included as part of a network game, included later as an add-on to a network game, or may be a stand-alone application running on a communication device that may be accessed by a network game to utilize features made available through the gaming tool. The gaming tool may be configured to control an image recognition process of a captured digital image, control a process for identifying a player based on the image recognition process, and/or control a gaming operation based on the identified player.

Although the gaming tool may be applicable to different network games for controlling different network gaming operations, the network game referenced throughout this disclosure may be a first person shooter type of network game. Within the context of this network game, a player may operate their respective communication device to capture a digital image (e.g., digital photograph or digital video) of a physical scene, where the physical scene may include one or more body parts of another player. The another player may be another player participating in the network game by running the same network game on their respective communication device. The scene image may be captured by an image capturing device included in the communication device. Each scene image captured by the communication device may be interpreted by the gaming tool to be a gaming operation (e.g., having taken a “shot”) by the player having captured the scene image within the network game. When it is determined that the captured scene image contains image data representative of the other player, the gaming tool may interpret the identification of the other player as a gaming operation being applied to the other player (e.g., the other playing being “shot”) within the network game.

The gaming tool may apply certain image processing options on the captured image to improve extraction of body characteristic information from the captured image, as disclosed in further detail herein. In addition, the gaming tool may further control operation of the image capturing device prior to the image capture, thereby providing guidance to the player that may improve a quality of the image that will be captured. In addition, the gaming tool may further control operation of the image capturing device prior to the image capture, thereby adjusting attributes of the communication device and/or the network game that may improve a quality of the image that will be captured. The gaming tool may be software, hardware, middleware, or any combination thereof, included on a communication device for implementing one or more of the features described in this disclosure.

The communication device described throughout this disclosure may be configured to allow for network communication with other similarly configured communication device to implement game-play features of the network game through one or more networks. The communication device may also include an image capturing device and an image recognition device for implementing the features described herein. The communication device may include well known computing systems, environments, and/or configurations suitable for implementing features of the network security protocol described herein such as, but are not limited to, smart phones, tablet computers, personal computers (PCs), server computers, handheld or laptop devices, multiprocessor systems, microprocessor-based systems, network PCs, server computers, minicomputers, mainframe computers, embedded systems, distributed computing environments that include any of the above systems or devices, and the like.

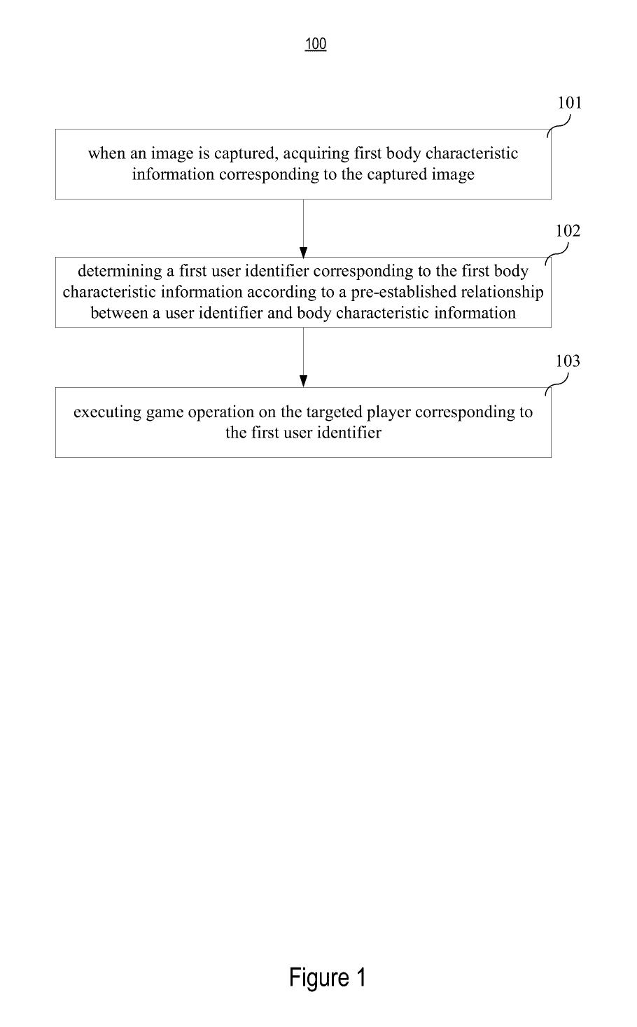

FIG. 1 shows a flow chart 100 of logic that may be undertaken by the gaming tool to implement an image recognition process on an image captured by the communication device within a context of the game, according to an exemplary embodiment. As shown in FIG. 1, a gaming operation may be implemented based on the image recognition process.

When an image is captured by the communication device (e.g., by a player controlling the communication device), first body characteristic information may be acquired by the gaming tool from the captured image (101). For example, the captured image may include image information representative of a physical scene, where the physical scene includes one or more bodily attribute of another player (e.g., targeted player) of the game. The first body characteristic information may be, for example, facial features such as face shape/size, nose shape/size, mouth shape/size, recognizable marks (e.g. mole shape/size/location), or other recognizable facial feature of the targeted player in the captured image. The first body characteristic information may be, for example, other physical attributes of the targeted player in the captured image such as height, torso, limbs, or other bodily attribute. The first body characteristic information may be, for example, clothes, accessories, jewelry, or parts thereof (e.g., shirt Collars, belts, gloves, rings, necklaces, shoes) worn by the targeted player in the captured image.

The first body characteristic information may be acquired by first identifying the targeted player in the captured image, communicating with a server storing physical attributes of players to look up the physical attributes of the targeted player, and receiving the physical attributes of the targeted player from the server as the first body characteristic information.

When the captured image is a self-portrait image of the communication device's user, the targeted player may be identified as an owner of the communication device. As the communication device may store first body characteristic information for the owner of the communication device, the first body characteristic information may be acquired by accessing the information from a memory of the communication device.

Once the first body characteristic information is acquired, a first user identifier corresponding to the first body characteristic information may be determined by the gaming tool based on whether a pre-established relationship between the first user identifier and the acquired first body characteristic information is satisfied (102). The first user identifier may be identification information (e.g., ID number) assigned to the targeted player depicted in the captured image. The first user identifier may be determined based on a parsing of a database of player information that stores user identifiers identifying players of the game and associated sample body characteristic information corresponding to each user identifier and relating to a bodily attribute of the respective player, identifying a sample body characteristic information that satisfies a matching relationship to the first body characteristic information within the database based on the parsing of the database, and identifying the first user identifier that corresponds to the identified sample body characteristic information. The first user identifier may identify, for example, the targeted player included in the captured image. It follows that the targeted player from the captured image may be identified from the first user identifier assigned to the targeted player, where the first user identifier is identified based on the first body characteristic information acquired from the captured image. The matching relationship between the acquired first body characteristic information and the sample body characteristic information may be a pre-established relationship that provides a matching criteria threshold for determining when a comparison of the first body characteristic information and the sample body characteristic information satisfies a matching criteria. For example, the matching relationship may be satisfied when a comparison of the first body characteristic information and the sample body characteristic information finds the two are similar enough to pass a certain similarity threshold, or when the sample body characteristic information includes the first body characteristic information.

Accordingly, the gaming tool may control a gaming operation (e.g., apply a shooting operation) on the targeted player corresponding to the first user identifier within the game (103). For example, the game may indicate the targeted player included in the captured image has been tagged (i.e., shot) within the gaming environment of the game. According to other embodiments, another gaming operation may be applied to the targeted player within the game based on the identification of the first user identifier. Although the disclosure describes the players of the game being connected in the gaming environment through a central server, the game may also be played in part when the players are offline. For example, when each communication device participating in the game stores the gaming information described herein for participating in the game in a local on-board memory, the game may be operated offline of the central server.

From the above, the relationship that correlates a player's user identifier to specific body characteristic information of the player may be pre-established. Then during game play of the game, the image may be captured by a communication device by a player, the first body characteristic information corresponding to the targeted player may be acquired from the captured image, the first user identifier corresponding to the targeted player captured in the image may be determined based on the first body characteristic information according to the correlation relationship, and the shooting operation may be executed on the targeted player identified by the first user identifier within the game. Therefore, flow chart 100 describes embodiments where the communication device is adapted to simulate a virtual gun used within a gaming environment of the game, such that capturing an image by the communication device is interpreted to simulate a shooting action on the targeted player by the communication device, and the targeted player identified in the captured image may be interpreted to have been shot by the player controlling the communication device having captured the image. It follows that the gaming tool according to flow chart 100 offers multiple players to utilize their own communication devices as virtual guns within the gaming environment by capturing images with an image capturing device included in their communication device. As such, if a certain targeted player is captured in an image, it is indicated that the targeted player included in the captured image is shot. This way, a separate dedicated special simulative gun is not needed to participate in the game. Flexibility is thus improved by removing a hurdle for players that would otherwise require players to purchase the dedicated special simulative guns to participate in the game.

According to some embodiments, the process described by flow chart 100 may further include capturing at least one image that includes at least one targeted player, acquiring body characteristic information of the at least one targeted player from the captured image according to image attributes extracted from the at least one image, and determining a relationship between the body characteristic information and a list of user identifiers to determine a user identifier corresponding to the at least one targeted player captured in the image.

According to some embodiments, the process described by flow chart 100 may further include capturing at least one image that includes at least one targeted player, acquiring body characteristic information of the at least one targeted player from the captured image according to image attributes extracted from the at least one image, and determining a relationship between the body characteristic information and a list of user identifiers to determine a user identifier corresponding to the at least one targeted player captured in the image.

According to some embodiments, the process described by flow chart 100 may further include capturing at least one image that includes at least one targeted player, acquiring body characteristic information of the at least one targeted player from the captured image according to image attributes extracted from the at least one image, and determining a relationship between the body characteristic information and a list of user identifiers to determine a user identifier corresponding to the at least one targeted player captured in the image.

According to some embodiments, the process described by flow chart 100 may further include judging whether the number of captured images taken by the communication device is larger than a preset number, when the number of the captured images is determined to be greater than the preset number, disabling an image capturing right or capability of the communication device, and re-establishing the right or capability of the communication device to capture images after a preset time length.

According to some embodiments, acquiring the first body characteristic information corresponding to the captured image as described in flow chart 100 may include determining a preset central area on the captured image, and processing attribute extraction on the preset central area to obtain the first body characteristic information.

According to some embodiments, determining the relationship may further include determining a relationship among a user identifier, a body part, and/or a body characteristic information, such that the process described by flow chart 100 may further include acquiring the first body characteristic information that corresponds to an identification of a first body part of the targeted player included in the captured image, such that determining the first user identifier is more specifically based on the identified first body part, and executing the shooting operation to apply to the player identified by the first user identifier. Executing the shooting operation may include executing the shooting operation to the first body part identified from the captured image.

According to some embodiments, executing the shooting operation on the targeted player identified by the first user identifier includes disabling a game right of the targeted player identified by the first user identifier, and or reducing a life value assigned to the targeted player identified by the first user identifier. When the life value of the targeted player identified by the first user identifier is lower than a preset threshold value, the process described by flow chart 100 may further include disabling the game right of the targeted player identified by the first user identifier.

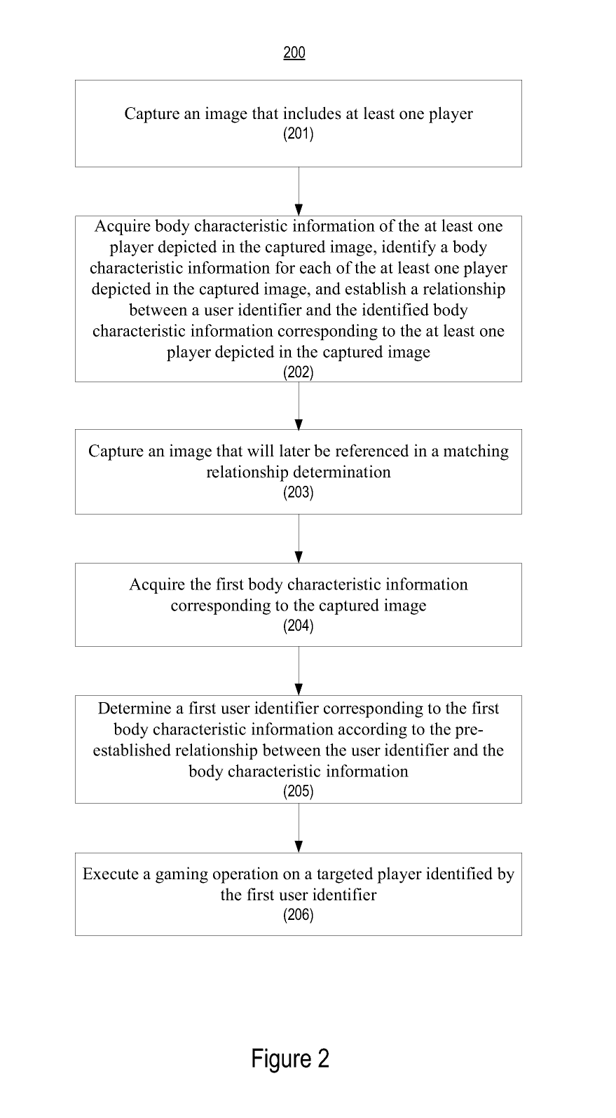

FIG. 2 shows a flow chart 200 of logic that may be undertaken by the gaming tool to implement an image recognition process on an image captured by the communication device within a context of the game, according to an exemplary embodiment. As shown in FIG. 2, a gaming operation may be implemented based on the image recognition process.

The communication device may capture an image that includes at least one player (201). For example, the captured image may include image information representative of a physical scene, where the physical scene includes one or more bodily attributes of the player of the game corresponding to the communication device.

To enhance game play flexibility, each player within a gaming environment created by the game may be equipped with a respective communication device for capturing images of scenes that may include another player. This way, the communication devices replace the need for a specially designed simulative gun for use during game play of the game (e.g., first person shooter game). When image information representing a certain player, or body attribute associated with the certain player, is identified as being included within a captured image taken, this may be interpreted by the gaming tool to simulate an action of shooting the player identified in the captured image. According to other embodiments, the identification of a player based on body characteristic information acquired from a captured image may be referenced to control a gaming operation, where the gaming operation may be associated with the player identified from the captured image.

Herein, the communication device may capture images and process the captured images, and also may display the captured images and the processed images on a display of the communication device. The communication device may be equipment such as a terminal, a server, or a mobile communication device, which is not limited in the embodiment.

In order to facilitate recognizing a player included in the scene represented by the captured image during game play, the communication device may capture at least one image of the scene where the scene includes at least one player. The gaming tool may then extract body characteristic information of one or more players included in the captured image before game play is started, where the one or more players are participants to the game.

According to some embodiments, each communication device participating in the game may be adopted for respective photographing, that is, each player may be captured by an image captured by their own respective communication device, and each communication device may capture at least one image that includes image information representative of their own corresponding player. Moreover, the multiple communication devices may interact with one another during game play of the game, and each communication device may transmit their locally captured images to other communication devices participating in the game.

The gaming tool acquires body characteristic information of one or more players according to the captured images that includes the one or more players, identifies a body characteristic for each of the one or more players from the captured images, and establishes a relationship between a user identifier and the identified body characteristic information corresponding to the one or more players (202).

The gaming tool may process the captured images to obtain the body characteristic information of each player on the basis of a characteristic extraction algorithm after capturing the at least one image of the one or more players. The body characteristic information is configured to correspond to a respective unique player, as different players have different body characteristic information.

Herein, the characteristic extraction algorithm may be a color-histogram-based characteristic extraction algorithm, a Hough transform algorithm, a template-matching-based characteristic extraction algorithm and the like, which is not limited in the embodiment. Correspondingly, the body characteristic information obtained by processing based on the characteristic extraction algorithm may be color characteristic information, posture characteristic information, face characteristic information of the images, which is not limited in the embodiment.

By capturing the images that include image data representative of the one or more players and performing the characteristic extraction on the captured images, the body characteristic information of the players may be acquired according to a face characteristic, iris characteristic, body posture, garment color or the like of each player.

In order to conveniently distinguish the players during the game play, the gaming tool may acquire a current login user identifier for a player logged into the game on a current communication device after the body characteristic information of each player is acquired, determine the relationship between the user identifier and body characteristic information of each player and determine the player associated with the specified body characteristic information identified from the determined relationship. Herein, the user identifier may be a user account for login of the player, an equipment number of the communication device, the name of the player, or the like, which is not limited in the embodiment.

In addition, in order to conveniently recognize a body part from the captured images of the players during the game play, the gaming tool may initially acquire body characteristic information for each applicable body part of each player from the captured images. The captured images may then be analyzed to acquire the body characteristic information of each body part for each player, and a relationship may be established among a user identifier, body part and body characteristic information of each player.

Herein, the gaming tool may prompt the player with a body part to be currently photographed by presenting a message on the communication device (e.g., display or audio output), the player may control the communication device to capture an image of their prompted body part, and the gaming tool may iterate through this process for each applicable body part, thereby acquiring body characteristic information of each body part for each player that may be stored as sample body characteristic information associated to the respective player's user identifier. The body part in the embodiment may include the head, the arms, the trunk, the lower limbs, or the like, which is not limited in the embodiment.

The communication device may be controlled to capture a new image that will later be referenced in a matching relationship determination (203).

Following steps (201) and (202), multiple players may start the game on their respective communication devices. During game play, each player may hold the communication device with their hand to capture a scene image that includes a physical scene, where the physical scene may include a targeted player. The identification of the targeted player, i.e. the shot player, represented by the image information included in the captured image may subsequently be determined based on a relationship that correlates the body characteristic information acquired from the captured image to a user identifier assigned to the targeted player.

In addition, in order to simulate shooting actions in the first-person shooter game and improve reality, the gaming tool may control the communication device to emit shooting sounds during an image capturing function.

In the first-person shooter game, when ammunition of the simulative guns represented by a player's communication device is exhausted, the players are required to supplement ammunitions to continue shooting, and may not unlimitedly shoot. Then, in order to simulate a game play scenario where ammunitions are exhausted in the embodiment, an image capturing right, i.e. a right of shooting another player, may be controlled and rationed by the gaming tool for each communication device participating in the game, where the image capturing right is controlled according to the number of images which have been taken by the corresponding communication device.

In an image capturing process, the gaming tool may track and update an image count that counts the current number of images captured by the communication device by monitoring the image capturing function on the communication device and detecting when an image is captured. Then, when the communication device takes an image as part of the game play (e.g., image capture corresponding to a shot action being taken within the game play), the current image count may be acquired, the image count is judged to determine whether the image count is larger than a preset number or not, and when the image count is determined to be larger than the preset number, it is indicated that the images taken by the communication device have exceeded a limit, the shooting right of the communication device is disabled, an image which is currently taken is ignored, and the image capturing right of the communication device is enabled again after a preset time length. That is, a countdown timing is recorded that tracks when the image capturing right of the communication device is disabled, and the photographing right of the communication device is enabled again when the recorded countdown time length reaches the preset time length.

In a subsequent process, the image count may be reset to be 0 after the image capturing right of the communication device is re-enabled, the current reset number of images which have been taken is recorded, and then the player may continue photographing the other players with their respective communication device.

Herein, the preset number may be determined by the communication device according to a preset game rule, or may be determined by negotiation between one or more multiple players participating in the game. The preset time length may be determined by the communication device according to the preset game rule, or may be determined according to a time length consumed by ammunition supplementation in the game, and there are no limits made in the embodiment.

In addition, in order to improve flexibility, the communication device may provide a resetting option when the image capturing right is in an on state. The resetting option may be configured to disable the image capturing right and set the image count to be 0. Thus, the player may initiatively click the resetting option at the right time. The image capturing right of the communication device may be disabled no matter how many images have been taken at present when the communication device detects selection of the resetting option (e.g., clicking operation over the resetting option that is displayed on a physical button the communication device or virtual button on a graphical user interface displayed on the communication device), and after the preset time length, the photographing right is enabled, and the current number of the images which have been captured by the communication device is set to be 0.

For example, the preset number may be 12, the preset time length may be 3 seconds. When the image count is 11 or the player is in a safer state and is not required to shoot the other players, the player may initiatively select the resetting option and the image capturing right of the communication device may be disabled. After 3 seconds, the image capturing right may be enabled again, and meanwhile, the image count is reset to be 0.

The gaming tool may acquire the first body characteristic information corresponding to the captured image (204).

The gaming tool may acquire the body characteristic information corresponding to the captured image, where the acquired body characteristic information may be assigned as first body characteristic information. Based on determining the first body characteristic, the player included in the captured image may be identified according to a matching process that matches the first body characteristic information to a user identifier that identifies the player determined to be included in the scene represented in the captured image (i.e., establishing a relationship between the first body characteristic information and a user identifier). Herein, a process of acquiring the body characteristic information from the captured image is similar to a process of acquiring the body characteristic information of each player according to the at least one image of each player in Step (202) of flowchart 200.

In addition, in order to improve image capturing accuracy, the player included in the scene captured by the captured image may also be determined only according to body characteristic information in a preset central area of the captured image. That is, the gaming tool may determine the preset central area of the captured image and perform characteristic extraction on the preset central area to acquire the first body characteristic information. The characteristic acquisition may not be performed on other areas outside the preset central area in the captured image.

Herein, the preset central area may be a circular area determined by taking the center of the captured image as the circle center and taking a preset distance as a radius. The preset central area may also be a square area determined according to a center of the captured image and extending out a preset distance along a width and a length that defines the square area, which is not limited in the embodiment.

Additionally, the player may be required to aim at the targeted player with their respective communication device when capturing an image of the targeted player during a game play of the game, and the gaming tool may control the communication device to capture an image of the targeted player when the targeted player is located in a field of view viewer provided on a display of the communication device. The viewer may display a field of view being captured by the image capturing device of the communication device. In particular, the gaming tool may require the targeted player to be within a targeted field displayed within the viewer. The targeted field may be a circle, square, arrows, or other displayable indicia displayed on the viewer for aligning the targeted player within the viewer. The targeted field may correspond to the preset central area of the captured image, such that waiting until the targeted player is within the targeted field to capture the image of the targeted player may allow for a higher probability, or even ensure, that the targeted player will be within the preset central area of the captured image. According to some embodiments, the communication device may not be allowed to capture the image until the targeted player is confirmed to be within the targeted field displayed on the viewer.

Similarly, in order to facilitate a image capturing function of the communication device participating in the game, the communication device may display a prompting identifier in the viewer that prompts the player to align the prompting identifier with the targeted player to ensure that the targeted player is aligned with the prompting identifier within the viewer when the image is captured. Herein, the prompting identifier may be a red point identifier, a crossed identifier or four arrows pointing to the center of the viewer.

The gaming tool may determine a first user identifier corresponding to the first body characteristic information according to the pre-established relationship between the user identifier and the body characteristic information (205).

For example, the first characteristic information acquired from the captured image may be referenced to locate a corresponding sample body characteristic stored in a table of body characteristic information mapped against user identifiers. The first body characteristic information acquired from the captured image may correspond to one or more identifiable body part of the targeted user. Then by locating the sample body characteristic information from the table based on the first body characteristic acquired from the captured image, the first user identifier that is mapped to the sample body characteristic information may be determined. If the first body characteristic information corresponding to a certain body part of the targeted player obtained from the captured image does not match any sample body characteristic information in the table, another first body characteristic information corresponding to another certain body part of the targeted player obtained from the captured image may be used to compare to the sample body characteristic information stored in the table to identify a first user identifier corresponding to the first body characteristic information. This comparison may be implemented until one or more first body characteristic information corresponding to body parts of the targeted player obtained from the captured image is matched to sample body characteristic information stored in the table. Alternatively, this comparison may be implemented until a successful matching relationship between the first body characteristic information acquired from the captured image and sample body characteristic information stored in the table is established.

It follows that the first user identifier may successfully be determined, where the first user identifier identifies the targeted player, i.e. the shot player, from the captured image. Following the identification of the targeted player based on the corresponding first user identifier, the gaming tool may control the communication device to display a shooting success prompting message that indicates the targeted player has been shot within the context of the game play.

In addition, when none of the first body characteristic information acquired from the captured image is determined to satisfy a matching relationship to the sample body characteristic information stored in the table, the gaming tool determines that the targeted player was not successfully captured by the captured image. This indicates that the player has not successfully shot the targeted player within the game. According to some embodiments, then the captured image may be deleted from a memory of the communication device to reduce an occupied storage space. At this time, the gaming tool may control the communication device to also display a shooting failure prompting message on the display of the communication device to indicate the targeted player was not successfully shot within the game.

The gaming tool may control execution of a gaming operation on the targeted player identified from the first user identifier (206). For example, a shooting operation type of gaming operation may be executed on the targeted player identified by the first user identifier.

Herein, the shooting operation may process the successful identification of the targeted player as determined by the identification of the first user identifier, by subjecting the targeted player to a “punishment” operation, where the “punishment operation may be determined according to the preset game rule. The gaming tool may execute the shooting operation on the targeted player identified by the first user identifier when determining the first user identifier.

For example, the shooting operation may include operation of disabling a game right of the targeted player identified by the first user identifier. That is, the game right of the targeted player identified by the first user identifier may be disabled within the gaming environment such that a status of the targeted player identified by the first user identifier may be set to a state of quitting the game after the communication device determines the targeted player identified by the first user identifier is disabled to perform an image capturing function on their respective communication device participating in the game.

Alternatively, the shooting operation may include an operation of reducing a life value of the targeted player identified by the first user identifier. That is, the game may maintain a life value of each player, so that the game may reduce the life value of the targeted player identified by the first user identifier when the targeted player identified by the first user identifier is determined to have been successfully shot within the game, and disables the game right of the targeted player identified by the first user identifier when determining that the life value of the targeted player identified by the first user identifier is lower than a preset threshold value in a subsequent process. Moreover, the gaming tool may reduce the life value of the targeted player identified by the first user identifier according to a preset difference.

Herein, the life value may be a numerical value within a preset range. The preset range may be determined according to the game rule. The preset threshold value may be a minimum value within the preset range. The preset threshold value may, for example, be 1 or another integer. The preset difference may also be determined according to the game rule. There are no limits made in the embodiment.

In addition, the pre-established relationship may include a relationship among the user identifier, the body part and the body characteristic information. For example, a table may store data sets where for a given player, the given player may be identified by a corresponding user identifier, where the corresponding user identifier relates to one or more sample body characteristic information describing one or more body parts identifiable from the player's body. So the gaming tool may execute the shooting operation on the body part of the targeted player captured in the captured image, where the body part is determined based on t the body characteristic obtained from the captured image that may be matched to the first body characteristic information image.

The gaming tool may further determine the shooting operation corresponding to each body part in advance, where the shooting operation may be applied differently to different body parts. Alternatively, the shooting operation may be applied the same across one or more different body parts. When determining that a first body characteristic information corresponding to a body part of the targeted player obtained from the captured image is matched with the sample body characteristic information, the gaming tool may identify the targeted player from the first user identifier and also identify any body parts corresponding to the targeted player that are detectable from the captured image according to sample body characteristic information matched to the first body characteristic information. The gaming tool may then implement a gaming operation (e.g., shooting operation) on the body parts related to the first body part.

For example, the gaming tool may determine a life value difference corresponding to each body part, and reduces the life value of the targeted player identified from the captured image according to the life value difference corresponding to the first body part when determining the targeted player identified from the captured image and the first body part. Herein, the life value deductions corresponding to different body parts may be the same or different, the life value deductions corresponding to each body part may also be determined according to importance of the body part. The corresponding life value deductions may be greater when the body parts are more important, and the corresponding life value deductions may be smaller when the body parts are more unimportant.

For example, the preset threshold value may be 1, a life value deduction of the head may be 100, a life value deduction of the trunk may be 20, a life value deduction of the arms may be 10 and a life value deduction of the lower limbs may be 5. An initial life value of the player may be 100 at the beginning of the game. If the head of the player is captured in an image and successfully identified according to any one or more of the processes described herein, the life value may be deducted based on the life value deduction 100 of the head, and thus the remaining life value of the player may be 0. The game right of the player may be directly disabled accordingly. If the trunk of the player is captured in the image, the life value of the player may be deducted based on the life value deduction 20 of the trunk and thus the remaining life value of the player is 80. When the life value is reduced to be 0 after the player is successfully shot within the game, the game right of the player may be disabled.

It is noted that the player may play the game for many rounds but a validity duration of the game right is only one round. That is, after the game right of a certain player is disabled, the player may not play the game in this round, but the game right of the player may be re-certified again at the beginning of the next round of the game after this round of the game ends, and at this time, the player may rejoin the game.

In addition, a user identifier for login of the communication device capturing the images may be employed as a second user identifier, and then the shooting completion operation may also be executed on the communication device identified by the second user identifier when the shooting processing operation is to be executed on the targeted player identified by the first user identifier. The shooting completion operation represents that any player shooting another player shall be subjected to a “rewarding” operation, and may be determined according to the preset game rule, which is not limited in the embodiment.

For example, the shooting completion operation may include operation of increasing the life value, that is, the gaming tool may increase the life value within the game of the player associated with the second user identifier after determining the communication device identified by the second user identifier has successfully shot the other player. Moreover, the gaming tool may also increase the life value within the game of the player associated with the second user identifier according to the preset deductions.

In addition, when the pre-established relationship includes the relationship among the user identifier, the body part and the body characteristic information, the gaming tool may also execute the shooting completion operation corresponding to the body part on the player associated with the second user identifier within the game according to the body part corresponding to the first body characteristic information of the captured image.

That is, the gaming tool may determine the shooting completion operation corresponding to each body part in advance, and the shooting completion operation corresponding to different body parts may be the same, and may also be different. After determining the first body part which is shot, the gaming tool may determine the shooting completion operation corresponding to the first body part and execute the determined shooting completion operation on the player associated with the second user identifier within the game. For example, the gaming tool may increase the life value of the player associated with the second user identifier according to the life value deduction/increase assigned to the first body part.

In addition, an initial score may be allocated to each player participating in the game according to their respective user identifier, and the score of each player may be updated according to game data such as shooting times, hitting times and shot times of the player. Correspondingly, the gaming tool may reduce the score of the player identified by the first user identifier when determining the player identified by the first user identifier has been shot, and may increase the score of the player associated with the second user identifier when determining the player associated with the second user identifier has successfully shot another player. At the end of the current round of the game, a final score of each player may be tallied according to their respective user identifier, i.e. a final score of each player may be determined.

In the embodiment, the communication device is adopted for the shooting game. For example, in a game process in which player A and player B participate in the game, each of player A and player B are equipped with their own communication device. Player A and player B may control their respective communication devices to capture images of themselves before the game is started in order to store body characteristic information of player A and player B, respectively. Player A and player B may also control their respective communication devices to capture images of other players participating in the game before the game is stated in order to store body characteristic information of the other players. After the game is started, player A may capture an image of player B that may be referenced for a matching relationship. For example, the gaming tool may determine that player B has been shot based on successfully identifying player B from the captured image based on a detected body characteristic information extracted from the captured image. The gaming tool may then disable a game right of player B or reduce a life value of player B based on which body part of player B has been identified by the detected body characteristic information. The gaming tool may also increase a score of player A based on player A successfully having shot player B.

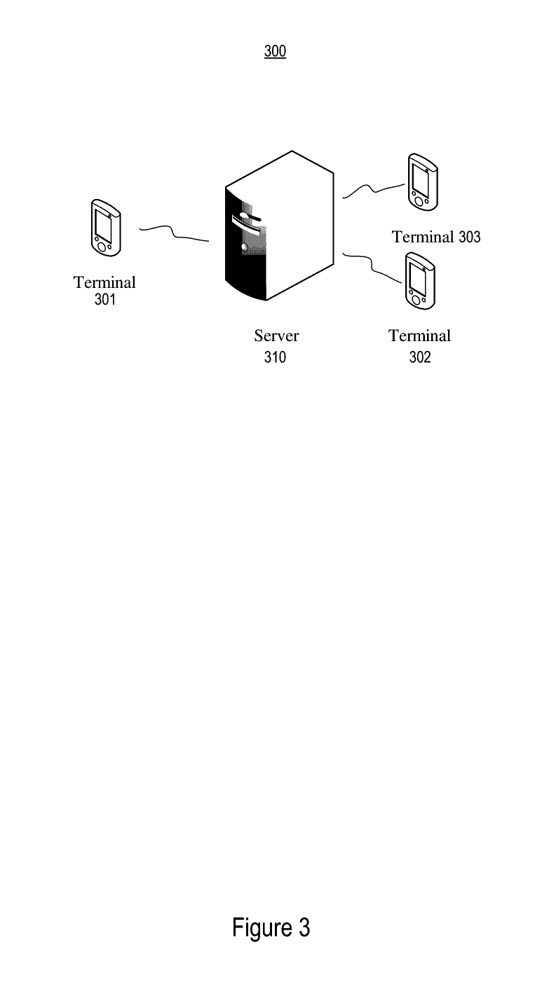

FIG. 3 is a system diagram illustrating an image recognition system 300 for a game, according to an exemplary embodiment. Referring to FIG. 3, the image recognition system 300 for the game includes a server 310 and multiple terminals (e.g., communication devices) represented by first terminal 301, second terminal 302, and third terminal 303. The server 310 is in communication with the first terminal 301, the second terminal 302, and the third terminal 303 through a network. The network described herein may include a wired, or wireless, network configured to couple a communication device with other client devices coupled to the network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example. For example, the network described herein may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within the network, or the like.

Each of the first terminal 301, the second terminal 302, and the third terminal 303 may be configured to capture an image for matching, and also transmit the captured image to the server 310. For example, the captured image may include image information representative of a physical scene, where the physical scene includes one or more bodily attribute of another player (e.g., targeted player) of the game. The server 310 may be configured to acquire first body characteristic information corresponding to the captured image, determine a first user identifier corresponding to the first body characteristic information according to a pre-established relationship between a user identifier and body characteristic information, as described with reference to the process for determining the first user identifier in flow chart 200 and flowchart 300. The first body characteristic information may be determined by the gaming tool running on the server. The gaming tool running on the server may also execute a gaming operation (e.g., shooting operation) on a player identified by the first user identifier within the game.

Alternatively, each of the first terminal 301, the second terminal 302, and the third terminal 303 may be configured to capture the image for matching, acquire the first body characteristic information corresponding to the captured image, determine the first user identifier corresponding to the first body characteristic information according to the pre-established relationship between the user identifier and the body characteristic information, and transmit the first user identifier to the server 310. The gaming tool running on the server may also execute a gaming operation (e.g., shooting operation) on a player identified by the first user identifier within the game.

Alternatively, each of the first terminal 301, the second terminal 302, and the third terminal 303 may be configured to capture the image for matching, acquire the first body characteristic information corresponding to the captured image and transmit the first body characteristic information to the server 310. The server 310 may be configured to determine the first user identifier corresponding to the first body characteristic information according to the pre-established relationship between the user identifier and the body characteristic information, as described with reference to the process for determining the first user identifier in flow chart 200 and flowchart 300. The first body characteristic information may be determined by the gaming tool running on the server. The gaming tool running on the server may also execute a gaming operation (e.g., shooting operation) on a player identified by the first user identifier.

Alternatively, each of the first terminal 301, the second terminal 302, and the third terminal 303 may be configured to capture the image for matching and transmit the captured image to the server 310. The server 310 may be configured to acquire the first body characteristic information corresponding to the captured image and transmit the first body characteristic information to the terminal which has captured the image. The terminal may further be configured to determine the first user identifier corresponding to the first body characteristic information according to the pre-established relationship between the user identifier and the body characteristic information, and transmit the first user identifier to the server 310. The gaming tool running on the server may also execute a gaming operation (e.g., shooting operation) on a player identified by the first user identifier.

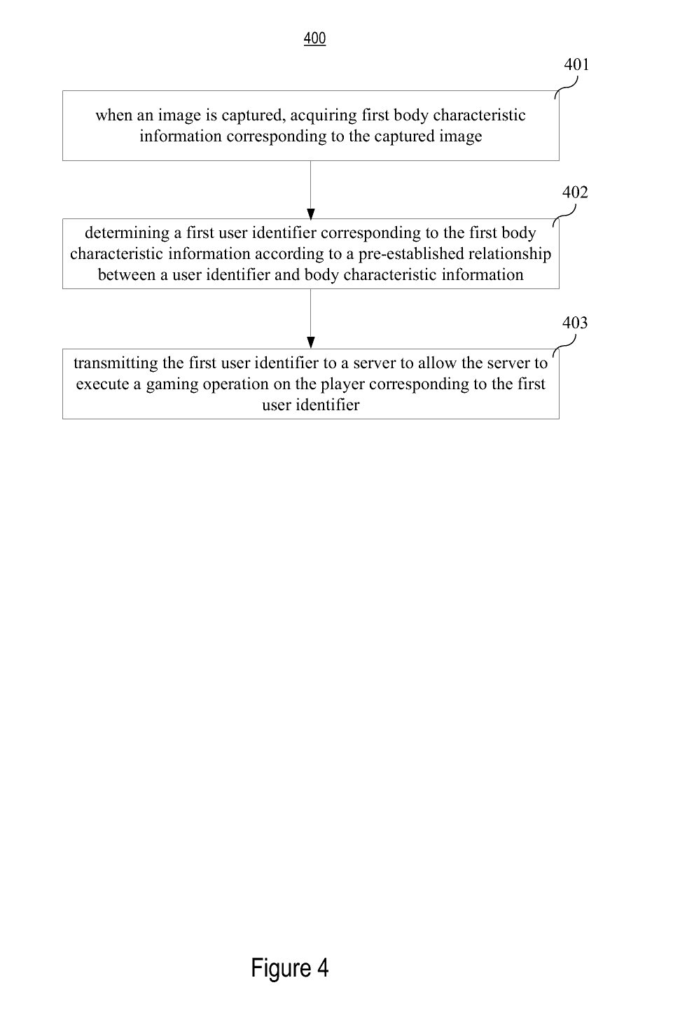

FIG. 4 shows a flow chart 400 of logic that may be undertaken by the gaming tool included as part of the game running, at least in part, on a communication device and a server to implement an image recognition process on an image captured by the communication device within a context of the game, according to an exemplary embodiment.

When an image for matching is captured by a communication device, the gaming tool may acquire a first body characteristic information corresponding to the captured image (401).

The gaming tool may determine a first user identifier corresponding to the first body characteristic information according to a pre-established relationship between a user identifier and body characteristic information (402).

The gaming tool may control the communication device to transmit the first user identifier to a server to enable the server to execute a gaming operation (e.g., shooting operation) on a player identified by the first user identifier within the game.

From the above, the relationship between the user identifier and the body characteristic information is pre-established, and during the game, the image for matching is captured, the first body characteristic information corresponding to the captured image is acquired, the first user identifier corresponding to the first body characteristic information is determined according to the relationship, and the shooting operation is executed on the player identified by the first user identifier. According to the embodiment, the communication device may be adopted to simulate a simulative gun required in the game and a manner of capturing the image by the communication device is adopted to simulate a shooting action. Thus, multiple players may be equipped with their own respective communication device, and when a certain player is captured in an image, the certain player included in the captured image may be identified as being shot within the game. A special simulative gun is not required to be equipped in the game, so that limits of simulative guns are broken, and flexibility is improved.

In another embodiment, the image recognition process further includes photographing at least one player to capture at least one image of the at least one player respectively, acquiring body characteristic information of each player according to the at least one image of each player, and establishing a relationship between a user identifier and body characteristic information for each player captured in the least one image.

In another embodiment, the image recognition process may further include photographing a current player to capture at least one image of the current player, transmitting the at least one image of the current player to the server to enable the server to acquire body characteristic information of the current player according to the at least one image of the current player and establish a relationship between a local user identifier and the body characteristic information, and receiving the relationship established by the server.

In another embodiment, the image recognition process may further include judging whether the number of images which have been captured by the communication device is larger than a preset number or not, when the number of captured images is determined to be larger than the preset number, disabling a photographing right, and certifying an image capturing feature of the communication device after a preset time length.

In another embodiment, acquiring the first body characteristic information corresponding to the captured image includes determining a preset central area of the captured image, and performing characteristic extraction on the preset central area to obtain the first body characteristic information.

In another embodiment, the relationship further includes a relationship among a user identifier, a body part and body characteristic information, such that the image recognition process may further include determining a first body part and a first user identifier corresponding to the first body characteristic information according to the relationship.

In another embodiment, the image recognition process may further include receiving a message of disabling a game right from the server, the message being transmitted when the server disables the game right according to the first user identifier, and displaying the message on a display of the communication device.

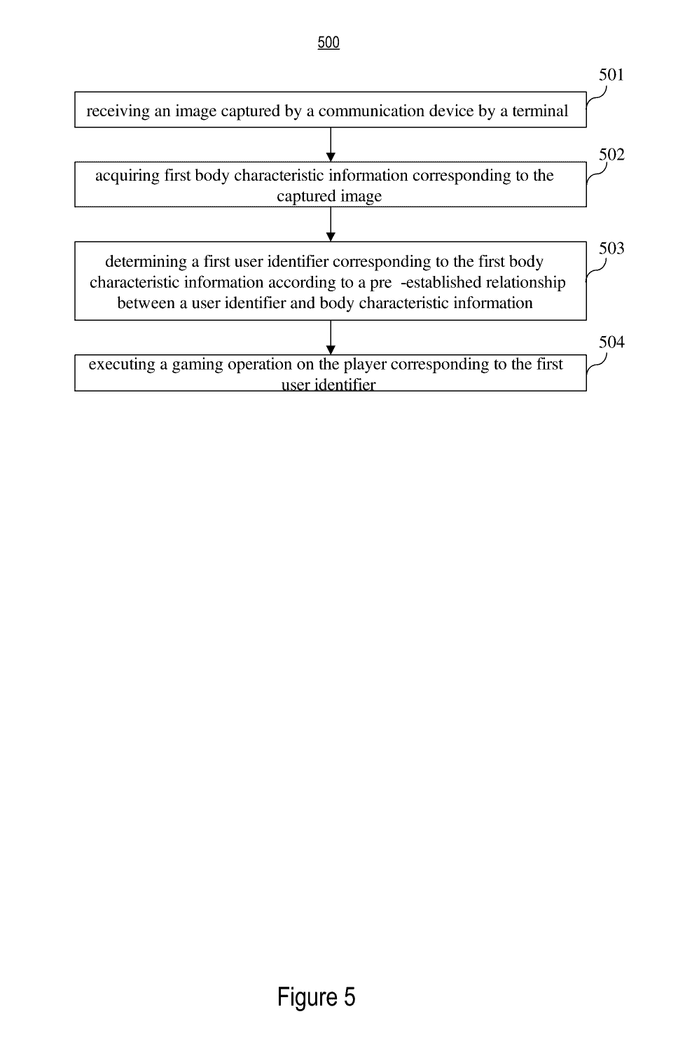

FIG. 5 shows a flow chart 500 of logic that may be undertaken by the gaming tool included as part of the game running, at least in part, on a communication device and a server to implement an image recognition process on an image captured by the communication device within a context of the game, according to an exemplary embodiment. As shown in FIG. 5, the image recognition process may be implemented, at least in part, on the server.

The gaming tool running on the server may be configured to receive an image captured by an image capturing device included in a terminal (e.g., communication device) (501).

The gaming tool running on the server may further be configured to acquire first body characteristic information corresponding to the captured image (502).

The gaming tool running on the server may further be configured to determine a first user identifier corresponding to the first body characteristic information according to a pre-established relationship between a user identifier and body characteristic information (503).

The gaming tool running on the server may further be configured to execute a gaming operation (e.g., shooting operation) on a player identified by the first user identifier within the game (504).

From the above, the relationship between the user identifier and the body characteristic information is pre-established, and during the game, the captured image may be captured, the first body characteristic information corresponding to the captured image may be acquired, the first user identifier corresponding to the first body characteristic information may be determined according to the relationship, and the shooting operation may be applied on the player identified by the first user identifier. According to the embodiment, a shooting action is simulated by acquiring the image captured by the terminal. Thus, multiple players may upload the images captured by the terminals to the server respectively, and the server performs image processing on the acquired images to indicate that a certain player identified from the captured images has been shot within a context of the game. A special simulative gun is not required to be equipped in a game, so that limits of simulative guns are broken, and flexibility is improved.

In another embodiment, the process further includes receiving at least one image transmitted by the terminal, the at least one image being obtained by photographing a current player by the terminal, acquiring body characteristic information of the current player according to the at least one image, and establishing a relationship between a user identifier of the terminal and the body characteristic information.

In another embodiment, the processer further includes judging whether the number of images which have been captured by the terminal is larger than a preset number or not, when the number of the images which have been captured by the terminal is determined to be larger than the preset number, disabling a photographing right of the terminal, and certifying (e.g., allowing) an image capturing right of the terminal after a preset time length.

In another embodiment, acquiring the first body characteristic information corresponding to the captured image may include determining a preset central area of the captured image, and performing characteristic extraction on the preset central area to obtain the first body characteristic information.

In another embodiment, the relationship may further include a relationship among a user identifier, a body part and body characteristic information, and the process may further include determining a first body part and a first user identifier corresponding to the first body characteristic information according to the relationship, and executing the shooting processing operation on the player identified by the first user identifier. Wherein executing the shooting operation on the player identified by the first user identifier may include executing the shooting operation corresponding to the first body part on the player identified by the first user identifier.

In another embodiment, executing the shooting operation on the player identified by the first user identifier may include disabling a game right of the player identified by the first user identifier within the game, or reducing a life value of the player identified by the first user identifier, and if the life value of the player identified by the first user identifier is lower than a preset threshold value, disabling the game right of the player identified by the first user identifier.

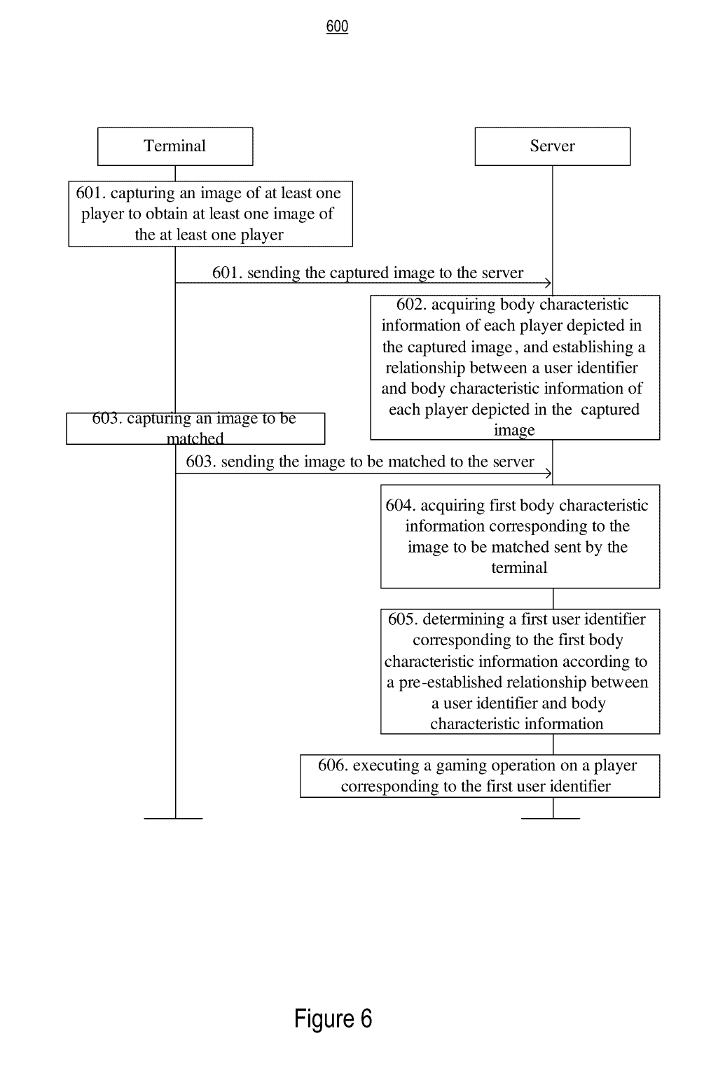

FIG. 6 shows a flow chart 600 that may be undertaken by the gaming tool included as part of the game running, at least in part, on a terminal and a server to implement an image recognition process on an image captured by the terminal within a context of the game, according to an exemplary embodiment.

The gaming tool running on the terminal may photograph at least one player to capture at least one image of the at least one player respectively, and transmit the at least one image to the server (601).

Step 601 may be similar to the process for capturing the image described with reference to Step 201, and will not be repeated in further detail.

The gaming tool running on the server may acquire a body characteristic information for each player in the captured image according to the at least one image of each player, and establish a relationship between a user identifier and body characteristic information for each player (602).

Step 602 may be similar to the process for acquiring the body characteristic information described with reference to Step 202, and will not be repeated in further detail.

The gaming tool running on the terminal may capture an image for matching, and transmit the captured image to the server (603).

The gaming tool running on the server may acquire a first body characteristic information corresponding to the captured image according to the captured image which is transmitted by the terminal (604).

The gaming tool running on the server may determine a first user identifier corresponding to the first body characteristic information according to a pre-established relationship between a user identifier and body characteristic information (605).

The gaming tool running on the server may execute a gaming operation (e.g., shooting operation) on a player identified by the first user identifier (606).

Step 604 to Step 606 may be similar to the process for acquiring the first body characteristic information described with reference to Step 204 to Step 206, and will not be repeated in further detail.

In addition, after executing the shooting operation, the server may transmit a prompting message to the terminal having captured the image, and the prompting message may be displayed on a display of the terminal to indicate that the shooting operation has been applied to the player identified by the first user identifier, and that the player identified by the first user identifier has been shot by a current player associated with the terminal having captured the image. Alternatively, the server may also transmit the prompting message to the terminal, and then the terminal may display the prompting message indicating that the shooting operation has been applied to the player identified by the first user identifier, thus indicating the player identified by the first user identifier has been shot within the game.

For example, the server transmits a game right disabling message to the terminal corresponding to the first user identifier when disabling a game right of the player identified by the first user identifier, and the terminal corresponding to the first user identifier displays the message to prompt that the current round of the game ends for the players.

In the embodiment, the terminal and the server are adopted for the shooter game. For example, there are multiple players, and a terminal of each players logs in to the server. Before the game starts, each players takes their own image to obtain their own image data such as clothes and body postures at any angle with their own terminal, and uploads the captured images to the server according to a login user identifier assigned to each player. The server performs characteristic extraction on the images uploaded by each terminal to obtain body characteristic information of each player, and establishes the relationship between the user identifier and the body characteristic information. After the game starts, the players photograph target players with their respective terminals, and upload the captured images to the server so that the captured images may be matched to corresponding body characteristic information and user identifiers. The server performs characteristic extraction on the captured images received from the terminals to obtain the first body characteristic information, and compares the first body characteristic information with the body characteristic information of each player, thereby determining which player has been shot.

From the above, the relationship between the user identifier and the body characteristic information is pre-established, and during the game, the server may acquire the first body characteristic information corresponding to the captured image by receiving the captured image from one or more terminals in communication with the server, determine the first user identifier corresponding to the first body characteristic information according to the relationship, and execute the shooting operation on the player identified by the first user identifier. According to the embodiment, the terminal may be adopted to simulate a simulative gun required in the game, and a manner of capturing images by the terminal may be adopted to simulate a shooting action within the game. Thus, multiple players may be equipped with their respective terminals, and after the images captured by the respective terminals are uploaded to the server, the server may perform image processing on the received images to indicate that a certain player included in an image captured by the terminal has been shot within the game. A special simulative gun is not required to be equipped in a game process, so that limits of simulative guns are broken, and flexibility is improved.

According to some embodiments, the terminal may implement Steps 601-603 to transmit the established relationship to the server. The server may execute Step 604 according to the relationship to acquire the first body characteristic information corresponding to the captured image transmitted by the terminal, and transmit the first body characteristic information to the terminal. The terminal may execute Step 605 according to the first body characteristic information to transmit the first user identifier corresponding to the first body characteristic information to the server, and then the server may execute Step 606 according to the first user identifier to execute the shooting operation on the player identified by the first user identifier.

Before the game starts, the terminal of each player may perform characteristic extraction on the captured images to obtain the body characteristic information of the corresponding player, establish the relationship between the login user identifier and the body characteristic information, and upload the relationship to the server. The server summarizes the relationship uploaded by each terminal to obtain the relationship including the user identifiers and body characteristic information of all the players, and transmits the relationship to each terminal. Each terminal may store the relationship. After the game starts, each player may control their respective terminal to capture an image that includes a targeted player, and upload the captured image to be matched to the server. The server may then perform characteristic extraction on the captured image to obtain the first body characteristic information, and transmit the first body characteristic information to the terminal. The terminal may compare the first body characteristic information with the stored body characteristic information to acquire the first user identifier corresponding to the body characteristic information matched with the first body characteristic information, and transmit the first user identifier to the server. The server may determine which player has been shot within the game according to the first user identifiers.

According to some embodiments, the terminal may execute Step 601 to transmit the captured images to the server. The server may execute Step 602 to establish the relationship between the user identifier and body characteristic information of each player and transmit the relationship to each terminal that may be participating in the game. Each terminal may store the relationship. Then, any one or more of the terminals participating in the game may execute Steps 603 to 605 to acquire the first user identifier corresponding to the captured images according to the stored relationship, and transmit the first user identifier to the server. The server may execute Step 606 according to the first user identifier to execute the shooting operation on the player identified by the first user identifier.

Before the game starts, the terminal of each player may perform characteristic extraction on the images which are captured to obtain the body characteristic information of the corresponding player and establish the relationship between the login user identifier and the body characteristic information, and upload the relationship to the server. The server summarizes the relationship uploaded by each terminal to obtain the relationship including the user identifiers and body characteristic information of all the player, and transmits the relationship to each terminal. Each terminal may store the relationship. After the game starts, each player may capture an image of the targeted player with their respective terminal. The terminal may then perform characteristic extraction on the captured image to obtain the first body characteristic information, compare the first body characteristic information with the stored body characteristic information to acquire the first user identifier corresponding to the body characteristic information matched with the first body characteristic information, and transmit the first user identifier to the server. The server may determine which player has been shot within the game.

According to some embodiments, the terminal may execute Step 601 to transmit the captured images to the server. The server may execute Step 602 to establish the relationship between the user identifier and body characteristic information of each player. Then, any one or more terminal participating in the game may execute Steps 603-604 to acquire the first body characteristic information corresponding to the captured image, and transmit the first body characteristic information to the server. The server may execute Steps 605-606 to determine the first user identifier corresponding to the first body characteristic information and execute the shooting operation on the player identified by the first user identifier.

Before the game starts, the terminal of each player may perform characteristic extraction on the images which are captured to obtain the body characteristic information of the corresponding player and establish the relationship between the login user identifier and the body characteristic information, and upload the relationship to the server. The server summarizes the relationship uploaded by each terminal to obtain the relationship including the user identifiers and body characteristic information of all the player, and transmits the relationship to each terminal. Each terminal may store the relationship. After the game starts, each player may capture an image of the targeted player with their respective terminal. The terminal may then perform characteristic extraction on the captured image to obtain the first body characteristic information, compare the first body characteristic information with the stored body characteristic information to acquire the first user identifier corresponding to the body characteristic information matched with the first body characteristic information, and transmit the first user identifier to the server. The server may determine which player has been shot within the game.

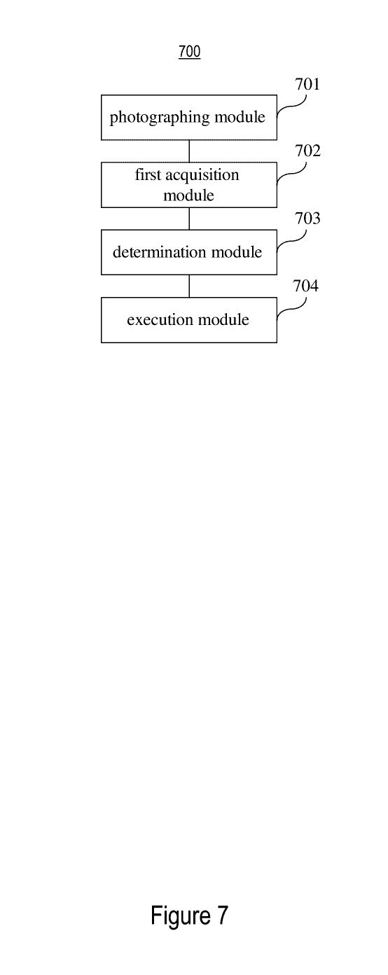

FIG. 7 shows a diagram showing structure of a terminal 700 (e.g., communication device) involved in implementing features of a game described herein, according to an exemplary embodiment. As shown in FIG. 7, the terminal 700 includes: a photographing module 701, a first acquisition module 702, a determination module 703 and an execution module 704. Each module may be a representation of hardware, software, middleware, circuitry, or any combination thereof.

The photographing module 701 may be configured to capture an image to be matched.

The first acquisition module 702 may be configured to acquire first body characteristic information corresponding to the captured image.

The determination module 703 may be configured to determine a first user identifier corresponding to the first body characteristic information according to a pre-established relationship between a user identifier and body characteristic information.

The execution module 704 may be configured to execute a shooting operation on a player identified by the first user identifier within the game.

From the above, the relationship between the user identifier and the body characteristic information is pre-established, and during the game, the image to be matched is captured by the terminal 700, the first body characteristic information corresponding to the captured image is acquired, the first user identifier corresponding to the first body characteristic information is determined according to the relationship, and the shooting operation is executed on the player identified by the first user identifier. According to the embodiment, the terminal 700 for the game is adopted to simulate a simulative gun required in the game, and a manner of capturing the image by the terminal 700 is adopted to simulate a shooting action. Thus, multiple players may be equipped with their respective terminals respectively, and if a certain player is captured in an image, the game may identify the certain player as being shot within the game. A special simulative gun is not required to be equipped in a game process, so that limits of simulative guns are broken, and flexibility is improved.

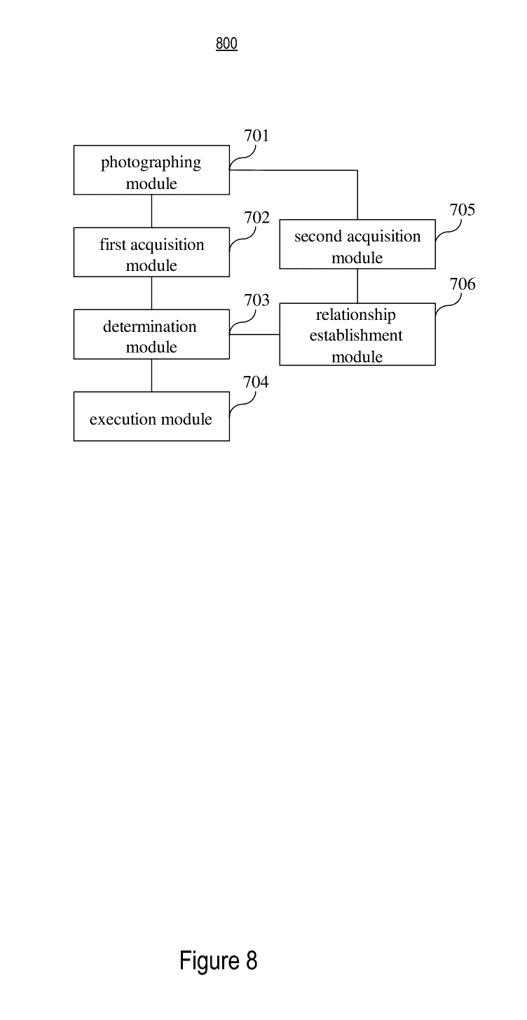

FIG. 8 shows a diagram showing structure of a terminal 800 (e.g., communication device) involved in implementing features of a game described herein according to another exemplary embodiment. The terminal 800 may further include a second acquisition module 705 and a relationship establishment module 706, when compared to terminal 700. Each module may be a representation of hardware, software, middleware, circuitry, or any combination thereof.

The photographing module 701 may be further configured to photograph at least one player to obtain at least one image of the at least one player respectively.

The second acquisition module 705 may be configured to acquire body characteristic information of each player according to the at least one image of each player.

The relationship establishment module 706 may be configured to establish a relationship between the user identifier and body characteristic information of each player.

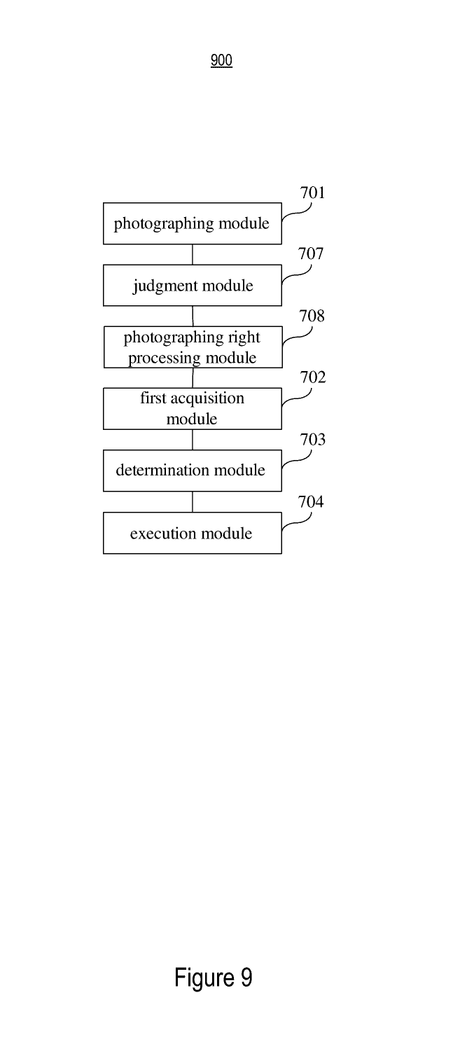

FIG. 9 shows a diagram showing structure of a terminal 900 (e.g., communication device) for implementing features of a game described herein according to another exemplary embodiment. The terminal 900 for the game may further include a judgment module 707 and a photographing right processing module 708, over terminal 700. Each module may be a representation of hardware, software, middleware, circuitry, or any combination thereof.

The judgment module 707 may be configured to judge whether the number of images which have been locally captured on the terminal 900 is larger than a preset number or not.

The photographing right processing module 708 may be configured to, when the number of images captured by the terminal 900 is determined to be larger than the preset number, disable a photographing right of terminal 900, and enable the photographing right of terminal 900 after a preset time length.

In another embodiment, the first acquisition module 702 may be further configured to determine a preset central area of the captured image, and perform characteristic extraction on the preset central area to obtain the first body characteristic information.

In another embodiment, the relationship may further include a relationship among a user identifier, a body part and body characteristic information, and the determination module 703 may be further configured to determine a first body part and first user identifier corresponding to the first body characteristic information according to the relationship.

The execution module 704 may be further configured to execute shooting processing operation corresponding to the first body part on the first user identifier.

In another embodiment, the execution module 704 may be further configured to disable a game right of the player identified by the first user identifier, or reduce a life value of the player identified by the first user identifier, and if the life value of the player identified by the first user identifier is lower than a preset threshold value, disable the game right of the player identified by the first user identifier.

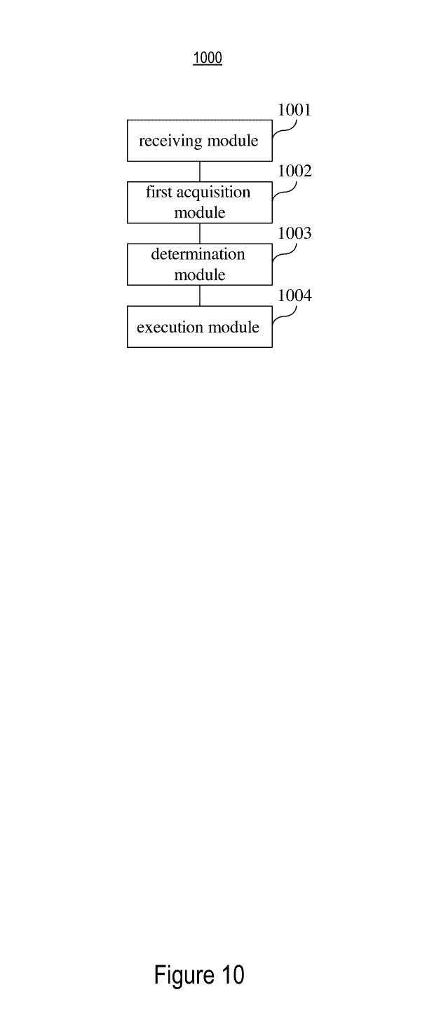

FIG. 10 shows a diagram showing structure for an image recognition device 1000 (e.g., terminal or server) involved in implementing features of a game described herein, according to another exemplary embodiment. As shown in FIG. 10, the image recognition device 1000 may include a receiving module 1001, a first acquisition module 1002, a determination module 1003 and an execution module 1004. Each module may be a representation of hardware, software, middleware, circuitry, or any combination thereof.

The receiving module 1001 may be configured to receive a captured image that will be analyzed to determine whether a matching relationship is satisfied, where the captured image is captured by a terminal (e.g., communication device).

The first acquisition module 1002 may be configured to acquire first body characteristic information corresponding to the captured image.

The determination module 1003 may be configured to determine a first user identifier corresponding to the first body characteristic information according to a pre-established relationship between a user identifier and body characteristic information.

The execution module 1004 may be configured to execute a shooting processing operation on a player identified by the first user identifier within the game.

From the above, the relationship between the user identifier and the body characteristic information is pre-established, and during the game, the image to be matched is captured by the terminal, the first body characteristic information corresponding to the captured image is acquired, the first user identifier corresponding to the first body characteristic information is determined according to the relationship, and the shooting operation is executed on the player identified by the first user identifier. According to the embodiment, a shooting action may be simulated by acquiring the image captured by the terminal. Thus, multiple users may upload the images captured by their respective terminals to a server respectively, and the server performs image processing on the acquired images to indicate that the player identified from the captured image has been shot within the game. A special simulative gun is not required to be equipped in a game, so that limits of simulative guns are broken, and flexibility is improved.

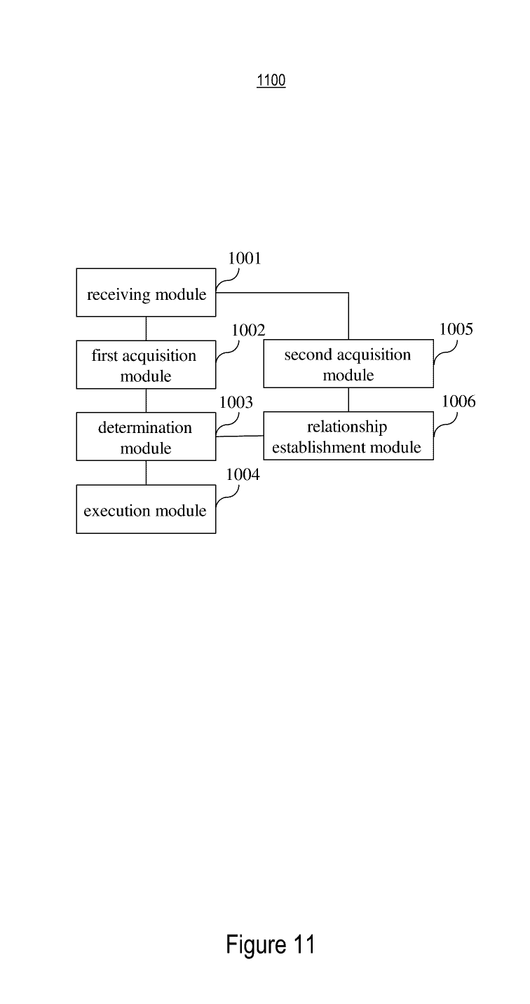

Referring to FIG. 11, shows a diagram showing structure for an image recognition device 1100 (e.g., terminal or server) involved in implementing features of a game described herein, according to another exemplary embodiment. The image recognition device 1100 may further include a second acquisition module 1005 and a relationship establishment module 1006 over the image recognition device 1000 shown in FIG. 10.

The receiving module 1001 may be further configured to receive at least one image transmitted to the image recognition device 1100 by a terminal (e.g., communication device), the at least one image being captured by the terminal to include a current player.

The second acquisition module 1005 may be configured to acquire body characteristic information of the current player according to the at least one image.

The relationship establishment module 1006 may be configured to establish a relationship between a user identifier of the terminal and the body characteristic information.

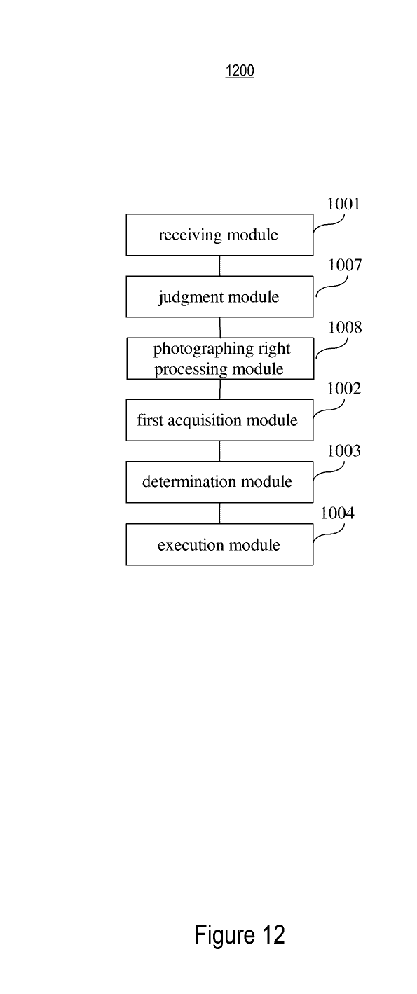

Referring to FIG. 12, shows a diagram showing structure for an image recognition device 1200 (e.g., terminal or server) involved in implementing features of a game described herein, according to another exemplary embodiment. The image recognition device 1200 may further include a judgment module 1007 and a photographing right processing module 1008 over the image recognition device 1100 shown in FIG. 11.

The judgment module 1007 may be configured to judge whether the number of images which have been captured by a terminal is larger than a preset number or not.

The photographing right processing module 1008 may be configured to, when the number of the images which have been captured by the terminal is determined to be larger than the preset number, disable an image capturing right of the terminal, and enable the image capturing right of the terminal after a preset time length.

In another embodiment, the first acquisition module 1002 is further configured to determine a preset central area of the image to be matched, and perform characteristic extraction on the preset central area to obtain the first body characteristic information.

In another embodiment, the relationship further includes a relationship among a user identifier, a body part and body characteristic information.

The determination module 1003 may be further configured to determine a first body part and first user identifier corresponding to the first body characteristic information according to the relationship.

The execution module 1004 is further configured to execute shooting processing operation corresponding to the first body part on a player identified by the first user identifier.

In another embodiment, the execution module 1004 may be further configured to disable a game right of the player identified by the first user identifier; or, reduce a life value of the player identified by the first user identifier, and if the life value of the player identified by the first user identifier is lower than a preset threshold value, disable the game right of the player identified by the first user identifier.

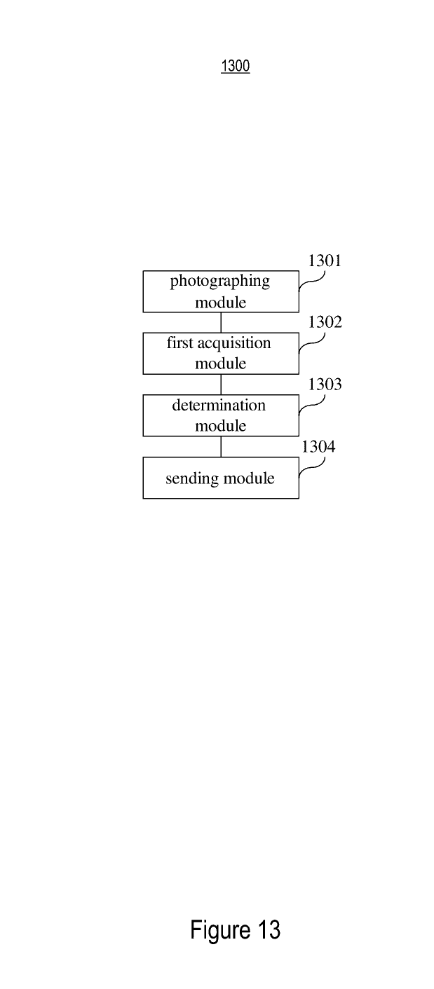

FIG. 13 shows a diagram showing structure for an image recognition device 1300 (e.g., terminal or server) involved in implementing features of a game described herein, according to another exemplary embodiment. The image recognition device 1300 may be a representation of a terminal. As shown in FIG. 13, the image recognition device 1300 may include a photographing module 1301, a first acquisition module 1302, a determination module 1303 and a sending module 1304.

The photographing module 1301 may be configured to capture an image to be matched.

The first acquisition module 1302 may be configured to acquire first body characteristic information corresponding to the image to be matched.

The determination module 1303 may be configured to determine a first user identifier corresponding to the first body characteristic information according to a pre-established relationship between a user identifier and body characteristic information.

The sending module 1304 may be configured to send the first user identifier to a server to enable the server to execute a shooting operation on the player identified by the first user identifier.

From the above, the relationship between the user identifier and the body characteristic information is pre-established, and during the game, the image to be matched is captured, the first body characteristic information corresponding to the image to be matched is acquired, the first user identifier corresponding to the first body characteristic information is determined according to the relationship, and the shooting operation is executed on the game identified by the first user identifier. According to the embodiment, the terminal may be adopted to simulate a simulative gun required in the game and a manner of taking the image by the terminal is adopted to simulate a shooting action. Thus, multiple users may be equipped with their respective terminals, and if a certain player is captured in an image, it may be indicated that the certain player has been shot. A special simulative gun is not required to be equipped in the game, so that limits of simulative guns are broken, and flexibility is improved.

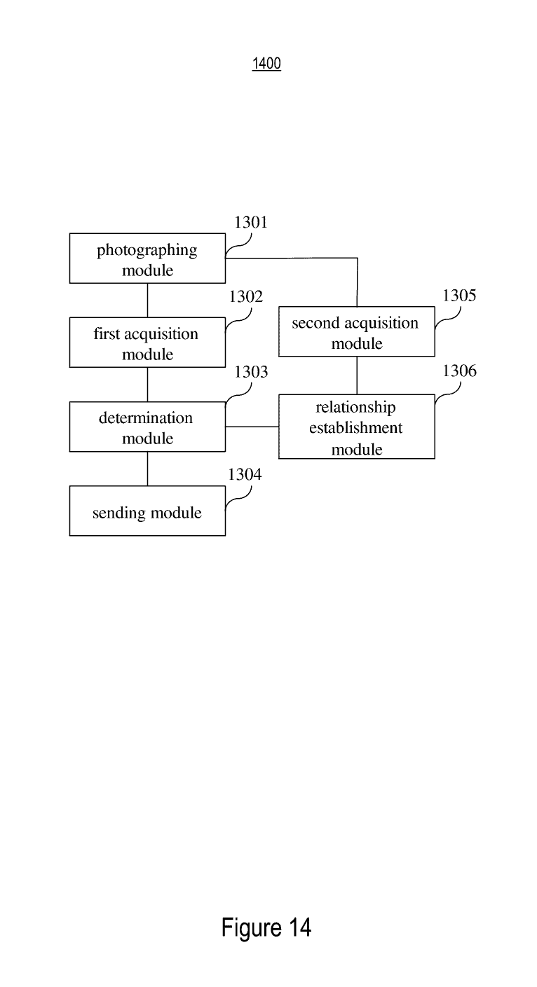

Referring to FIG. 14, shows a diagram showing structure for an image recognition device 1400 (e.g., terminal or server) involved in implementing features of a game described herein, according to another exemplary embodiment. The image recognition device 1400 may further include a second acquisition module 1305 and a relationship establishment module 1306 over the image recognition device 1300 illustrated in FIG. 13.

The photographing module 1301 may be further configured to photograph at least one player to obtain at least one image of the at least one player respectively.

The second acquisition module 1305 may be configured to acquire body characteristic information of each player according to the at least one image of each player.

The relationship establishment module 1306 may be configured to establish a relationship between a user identifier and body characteristic information of each player.

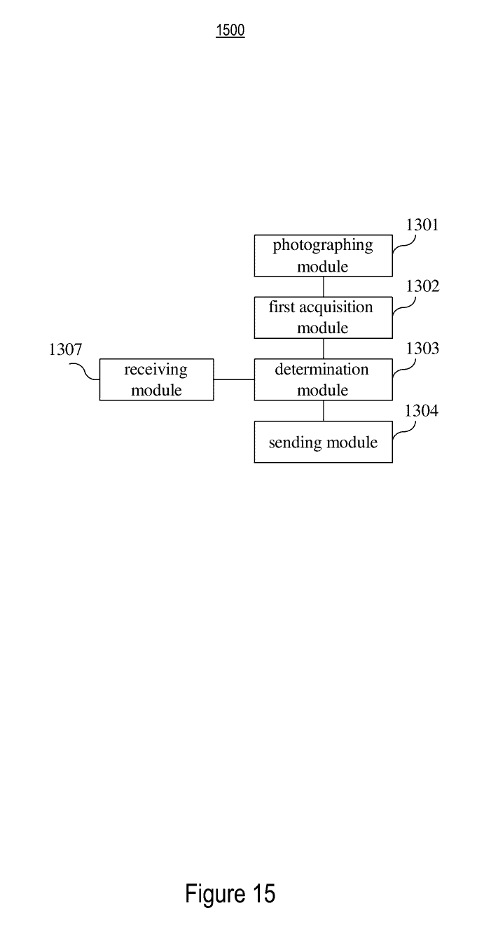

Referring to FIG. 15, shows a diagram showing structure for an image recognition device 1500 (e.g., terminal or server) involved in implementing features of a game described herein, according to another exemplary embodiment. The image recognition device 1500 may further include a receiving module 1307 over the image recognition device 1300 illustrated in FIG. 13.

The photographing module 1301 may be further configured to photograph a current player to obtain at least one image of the current player.

The sending module 1304 may be further configured to send the at least one image of the current player to a server to enable the server to acquire body characteristic information of the current player according to the at least one image of the current player and establish a relationship between a local user identifier and the body characteristic information.

The receiving module 1307 may be further configured to receive the relationship established by the server.

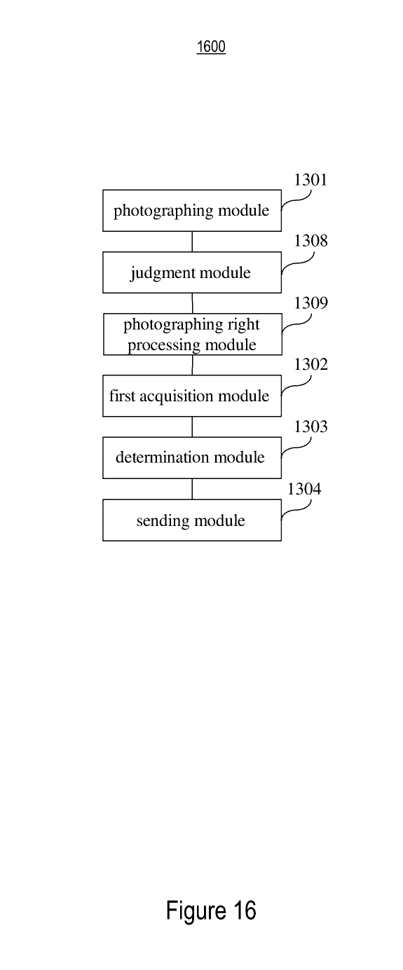

Referring to FIG. 16, shows a diagram showing structure for an image recognition device 1600 (e.g., terminal or server) involved in implementing features of a game described herein, according to another exemplary embodiment. The image recognition device 1600 may further include a judgment module 1308 and a photographing right processing module 1309 over the image recognition device 1300 illustrated in FIG. 13.

The judgment module 1308 may be configured to judge whether the number of images which have been captured is larger than a preset number or not.

The photographing right processing module 1309 may be configured to, when the number of the images which have been captured is determined to be larger than the preset number, disable an image capturing right, and enable the image capturing after a preset time length.

In another embodiment, the first acquisition module 1302 may be further configured to determine a preset central area of the image to be matched, and perform characteristic extraction on the preset central area to obtain the first body characteristic information.

The relationship may further include a relationship among a user identifier, a body part and body characteristic information, and the determination module 1303 may be further configured to determine a first body part and first user identifier corresponding to the first body characteristic information according to the relationship.

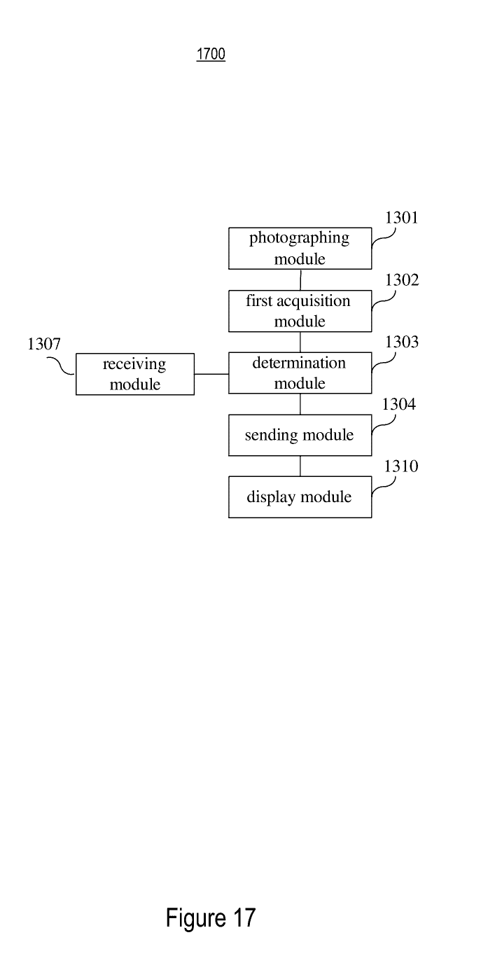

Referring to FIG. 17, shows a diagram showing structure for an image recognition device 1700 (e.g., terminal or server) involved in implementing features of a game described herein, according to another exemplary embodiment. The image recognition device 1700 may further include a receiving module 1307 and a display module 1310 over the image recognition device 1300 illustrated in FIG. 13.

The receiving module 1307 may be further configured to receive a message of disabling a game right from a server, the message being transmitted when the server disables the game right according to the player identified by the first user identifier.

The display module 1310 may be configured to display the message.

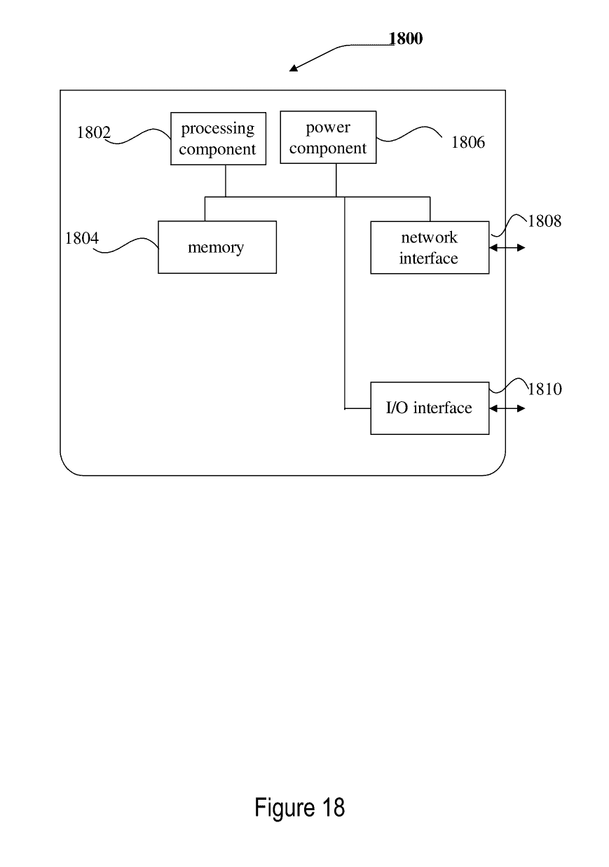

FIG. 18 shows a block diagram of an exemplary image recognition device 1800 (e.g., terminal or server) involved in implementing features of a game described herein. For example, the image recognition device 1800 may be provided as a server. Referring to FIG. 18, the image recognition device 1800 includes a processing component 1802, which may include one or more processors. The image recognition device 1800 further includes a memory resource represented by a memory 1804, where the memory may be configured to store instructions such as application programs and instructions executable by the processing component 1802 to implement features of a game, as described herein. The information stored in the memory 1804 may include one or more modules of which each corresponds to a set of instructions for implementing a specific feature described herein. In addition, the processing component 1802 may be configured to execute the instructions to implement the image recognition processes for a game described herein.

The image recognition device 1800 may further include a power component 1806 configured to execute power management of the image recognition device 1800, a wired or wireless network interface 1808 configured to connect the image recognition device 1800 to a network, and an Input/Output (I/O) interface 1810. The image recognition device 1800 may be operated on the basis of an operating system stored in the memory 1804, such as Windows Server™, Mac OS X™, Unix™, Linux™, FreeBSD™ or the like.

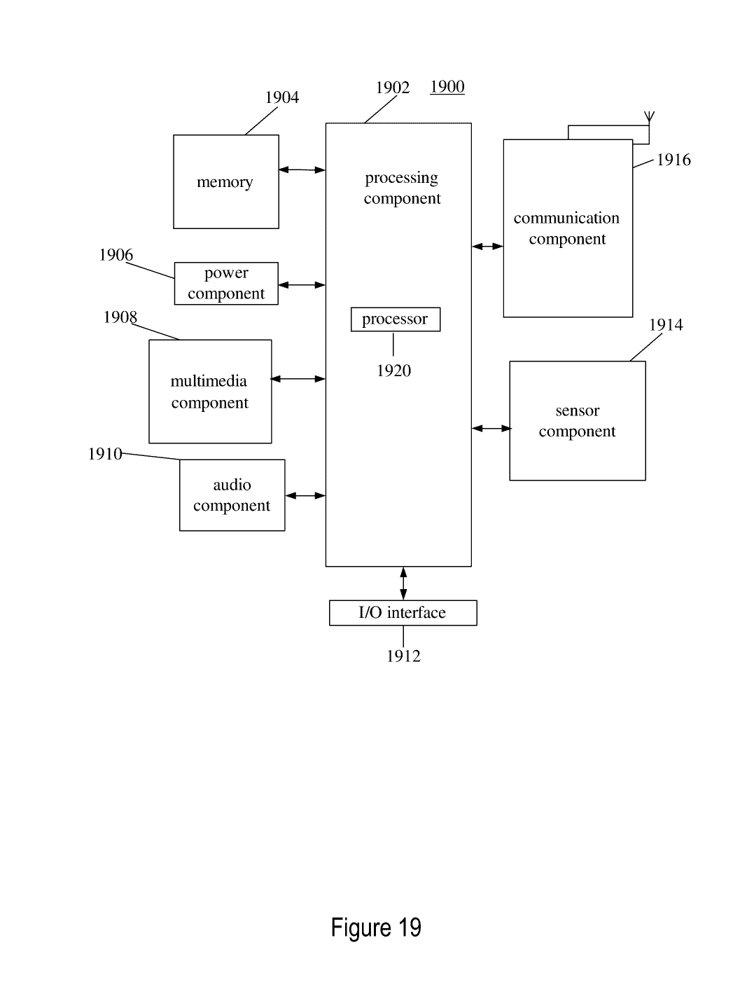

FIG. 19 shows a block diagram illustrating an exemplary image recognition device 1900 for implementing features of a game, according to an exemplary embodiment. For example, the image recognition device 1900 may be a mobile phone, a digital broadcast terminal, a messaging device, a gaming console, a tablet, a personal digital assistant and the like.

Referring to FIG. 19, the image recognition device 1900 may include one or more of the following components: a processing component 1902, a memory 1904, a power component 1906, a multimedia component 1908, an audio component 1910, an I/O interface 1912, a sensor component 1914, and a communication component 1916.

The processing component 1902 typically controls overall operations of the image recognition device 1900, such as the operations associated with display, telephone calls, data communications, camera operations, and recording operations. The processing component 1902 may include one or more processors 1920 to execute instructions to perform all or part of the steps in the abovementioned methods. Moreover, the processing component 1902 may include one or more modules which facilitate interaction between the processing component 1902 and the other components. For instance, the processing component 1902 may include a multimedia module to facilitate interaction between the multimedia component 1908 and the processing component 1902.

The memory 1904 may be configured to store various types of data to support the operation of the image recognition device 1900. Examples of such data include instructions for any applications or methods operated on the image recognition device 1900, contact data, phonebook data, messages, images, video, etc. The memory 1904 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or an optical disk.

The power component 1906 provides power for various components of the image recognition device 1900. The power component 1906 may include a power management system, one or more power supplies, and other components associated with the generation, management and distribution of power for the image recognition device 1900.

The multimedia component 1908 includes a screen providing an output interface between the device 1900 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action, but also sense a duration and pressure associated with the touch or swipe action. In some embodiments, the multimedia component 1908 includes a front camera and/or a rear camera. The front camera and/or the rear camera may receive external multimedia data when the image recognition device 1900 is in an operation mode, such as a photographing mode or a video mode. Each of the front camera and the rear camera may be a fixed optical lens system or have focusing and optical zooming capabilities.

The audio component 1910 is configured to output and/or input an audio signal. For example, the audio component 1910 includes a microphone (MIC), and the MIC is configured to receive an external audio signal when the image recognition device 1900 is in the operation mode, such as a call mode, a recording mode and a voice recognition mode. The received audio signal may be further stored in the memory 1904 or transmitted through the communication component 1916. In some embodiments, the audio component 1910 further includes a speaker configured to output the audio signal.

The I/O interface 1912 provides an interface between the processing component 1902 and a peripheral interface module, and the peripheral interface module may be a keyboard, a click wheel, a button and the like. The button may include, but are not limited to: a home button, a volume button, a starting button and a locking button.

The sensor component 1914 includes one or more sensors configured to provide status assessment in various aspects for the image recognition device 1900. For instance, the sensor component 1914 may detect an on/off status of the image recognition device 1900 and relative positioning of components, such as a display and small keyboard of the image recognition device 1900, and the sensor component 1914 may further detect a change in a position of the image recognition device 1900 or a component of the image recognition device 1900, presence or absence of contact between the user and the image recognition device 1900, orientation or acceleration/deceleration of the image recognition device 1900 and a change in temperature of the image recognition device 1900. The sensor component 1914 may include a proximity sensor configured to detect presence of an object nearby without any physical contact. The sensor component 1914 may also include a light sensor, such as a Complementary Metal Oxide Semiconductor (CMOS) or Charge Coupled Device (CCD) image sensor, configured for use in an imaging application. In some embodiments, the sensor component 1914 may also include an acceleration sensor, a gyroscope sensor, a magnetic sensor, a pressure sensor or a temperature sensor.

The communication component 1916 is configured to facilitate wired or wireless communication between the image recognition device 1900 and another device. The image recognition device 1900 may access a communication-standard-based wireless network, such as a Wireless Fidelity (WiFi) network, a 2nd-Generation (2G) or 3rd-Generation (3G) network or a combination thereof. In an exemplary embodiment, the communication component 1916 receives a broadcast signal or broadcast associated information from an external broadcast management system through a broadcast channel. In an exemplary embodiment, the communication component 1916 further includes a Near Field Communication (NFC) module to facilitate short-range communication. For example, the NFC module may be implemented on the basis of a Radio Frequency Identification (RFID) technology, an Infrared Data Association (IrDA) technology, an Ultra-WideBand (UWB) technology, a BlueTooth (BT) technology and another technology.

In the exemplary embodiment, the image recognition device 1900 may be implemented by one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to implement the abovementioned methods.

In the exemplary embodiment, there is also provided a non-transitory computer-readable storage medium including instructions, such as, the memory 1904 including instructions, and the instructions may be executed by the processor 1920 of the image recognition device 1900 to implement the abovementioned methods. For example, the non-transitory computer-readable storage medium may be a ROM, a Compact Disc Read-Only Memory (CD-ROM), a magnetic tape, a floppy disc, an optical data storage device and the like.

In an exemplary embodiment, there is also provided a non-transitory computer-readable storage medium, and when instructions in the storage medium are executed by the processor of the terminal, the terminal may execute the abovementioned image recognition methods for the game.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

### INDUSTRIAL APPLICABILITY

According to the methods and devices provided by the embodiments of the present disclosure, the relationship between the user identifier and the body characteristic information is pre-established, and during a game, the image to be matched may be captured, the first body characteristic information corresponding to the image to be matched is acquired, the first user identifier corresponding to the first body characteristic information is determined according to the relationship, and a shooting operation may be executed on a player identified by the first user identifier within the game. According to the embodiments, the communication device may be adopted to simulate a simulative gun required in the game and a manner of capturing the image by the communication device may be adopted to simulate a shooting action. Thus, multiple players may be equipped with their respective communication devices to participate in the game. As such, if a certain player is captured in a picture captured by a communication device participating in the game, the game may indicate that the certain player has been shot within the game. A special simulative gun is not required to be equipped in a game process, so that limits of simulative guns are broken, and flexibility is improved.

What is claimed is:

1. An image recognition method for a game, comprising:
receiving a captured image from an image capturing device;
acquiring a first body characteristic information corresponding to a bodily attribute from the captured image;
determining whether a first user identifier satisfies a matching relationship with the first body characteristic information; and
when the first user identifier is determined to satisfy the matching relationship with the first body characteristic information, performing a gaming operation on a player identified by the first user identifier.

2. The method of claim 1, further comprising:
receiving at least one image that includes at least one user;
acquiring body characteristic information of the at least one user included in the at least one image; and
determining a relationship between the body characteristic information of the at least one user and at least one user identifier.

3. The method of claim 1, further comprising:
monitoring a number of images captured by the image capturing device;
determining whether the number of images captured by the image capturing device is larger than a preset number;
when the number of images captured by the image capturing device is determined to be larger than the preset number, disabling an image capturing feature of the image capturing device; and
certifying the image capturing feature of the image capturing device after a preset time length.

4. The method of claim 1, wherein acquiring the body characteristic information corresponding to the at least one detectable player included in the captured image comprises:
determining a preset central area of the captured image; and
performing characteristic extraction on the preset central area to acquire the body characteristic information.

5. The method of claim 1, wherein the matching relationship further relates to a relationship among a user identifier, a body part identifier, and a body characteristic information, and wherein the method further comprises:
determining a first body part identifier corresponding to the first user identifier,
wherein executing the gaming operation on a user identified by the first user identifier comprises:
executing the gaming operation on a first body part identified by the first body part identifier.

6. The method of claim 1, wherein executing the gaming operation on the user identified by the first user identifier comprises at least one of:
disabling a game right of the user identified by the first user identifier; or
reducing a life value of the user identified by the first user identifier, disabling a game right of the user identified by the first user identifier when the life value of the user identified by the first user identifier is lower than a preset threshold value.

7. An image recognition method for a game, comprising:
receiving a captured image from an image capturing device;
acquiring a first body characteristic information corresponding to a bodily attribute from the captured image;
determining whether a first user identifier satisfies a matching relationship with the first body characteristic information; and
when the first user identifier is determined to satisfy the matching relationship with the first body characteristic information, transmitting the first user identifier to a server, wherein the server is configured to execute a gaming operation on a user identified by the first user identifier.

8. The method of claim 7, further comprising:
receiving at least one image that includes at least one user;
acquiring body characteristic information of the at least one user included in the at least one image; and
determining a relationship between the body characteristic information of the at least one user and at least one user identifier.

9. The method of claim 7, further comprising:
receiving at least one captured image that includes a current user;
transmitting the at least one captured image to the server, wherein the server is configured to acquire body characteristic information of the current user from the at least one captured image and determine a relationship between a local user identifier and the acquired body characteristic information; and
receiving the relationship determined by the server.

10. The method of claim 7, further comprising:
monitoring a number of images captured by the image capturing device;
determining whether the number of images captured by the image capturing device is larger than a preset number;
when the number of the images captured by the image capturing device is determined to be larger than the preset number, disabling an image capturing feature of the image capturing device; and
certifying the image capturing feature of the image capturing device after a preset time length.

11. The method of claim 7, wherein acquiring the body characteristic information corresponding to the at least one detectable player included in the captured image comprises:
determining a preset central area of the captured image; and
performing characteristic extraction on the preset central area to acquire the body characteristic information.

12. The method of claim 7, wherein the matching relationship further relates to a relationship among a user identifier, a body part identifier, and body characteristic information, and wherein the method further comprises:
determining a first body part identifier corresponding to the first user identifier.

13. The method of claim 7, further comprising:
receiving, from the server, a message indicating a game right of the user identified by the first user identifier has been disabled when the server disables the game right; and
displaying the message.

14. An image recognition device for a game, comprising:
a processor; and
a memory configured to store instructions executable by the processor to:
receive a captured image from an image capturing device;
acquire a first body characteristic information corresponding to a bodily attribute from the captured image;
determine whether a first user identifier satisfies a matching relationship with the first body characteristic information; and
when the first user identifier is determined to satisfy the matching relationship with the first body characteristic information, execute a gaming operation on a user identified by the first user identifier.

15. An image recognition device for a game, comprising:
a processor; and
a memory configured to store instructions executable by the processor to:
receive a captured image from an image capturing device;
acquire a body characteristic information corresponding to a bodily attribute from the captured image;
determine whether a first user identifier satisfies a matching relationship with the first body characteristic information; and
when the first user identifier is determined to satisfy the matching relationship with the first body characteristic information, transmit the first user identifier to a server, wherein the server is configured to execute a gaming operation on a user identified by the first user identifier.
